(19) United States
(12) Patent Application Publication
(10) Pub. No.: US 2026/0150053 A1
(43) Pub. Date: May 28, 2026

(54) MEASUREMENT SWITCHING METHOD AND APPARATUS, INFORMATION TRANSMISSION METHOD AND APPARATUS, TERMINAL, AND NETWORK SIDE DEVICE

(71) Applicant: VIVO MOBILE COMMUNICATION CO., LTD., Dongguan, Guangdong (CN)

(72) Inventors: Kai WU, Dongguan (CN); Xueming PAN, Dongguan (CN)

(73) Assignee: VIVO MOBILE COMMUNICATION CO., LTD., Dongguan, Guangdong (CN)

(21) Appl. No.: 19/409,385

(22) Filed: Dec. 4, 2025

Related U.S. Application Data
(63) Continuation of application No. PCT/CN2024/097442, filed on Jun. 5, 2024.

(30) Foreign Application Priority Data
Jun. 5, 2023 (CN) 202310657351.9
Sep. 20, 2023 (CN) 202311217986.3
Feb. 5, 2024 (CN) 202410164571.2
Jun. 3, 2024 (CN) 202410710435.9

(51) Int. Cl. H04W 52/02; H04L 27/04

(52) U.S. Cl. CPC H04W 52/0235; H04L 27/04

(57) ABSTRACT

The present application relates to the technical field of communications, and discloses a measurement switching method and apparatus, an information transmission method and apparatus, a terminal, and a network side device. The measurement switching method of embodiments of the present application comprises: a terminal acquires a first measurement result corresponding to a first measurement behavior; and the terminal determines, according to the first measurement result and a measurement switching threshold, whether to switch to a second measurement behavior, wherein the measurement switching threshold is related to the type of a low-power receiver of the terminal and/or the type of a signal measured by the low-power receiver.

### CROSS-REFERENCE TO RELATED APPLICATIONS

This application is a continuation application of PCT application No. PCT/CN2024/097442, filed on Jun. 5, 2024, which is incorporated herein by reference in its entirety. This PCT application claims priority to Chinese Patent Application No. 202310657351.9, filed in China on Jun. 5, 2023, which is incorporated herein by reference in its entirety. In addition, this PCT application claims priority to Chinese Patent Application No. 202311217986.3, filed in China on Sep. 20, 2023, which is incorporated herein by reference in its entirety. In addition, this PCT application claims priority to Chinese Patent Application No. 202410164571.2, filed in China on Feb. 5, 2024, which is incorporated herein by reference in its entirety. In addition, this PCT application claims priority to Chinese Patent Application No. 202410710435.9, filed in China on Jun. 3, 2024, which is incorporated herein by reference in its entirety.

### TECHNICAL FIELD

This application pertains to the field of communication technologies, and specifically, relates to a measurement switching method and apparatus, an information transmission method and apparatus, a terminal, and a network side device.

### BACKGROUND

One design of a low power control signal waveform uses a sequence modulated through orthogonal frequency division multiplexing (OFDM). An on-off keying (OOK) signal is formed by transmitting or not transmitting the sequence, and information is transmitted by using the OOK signal. Alternatively, further, a sequence of the OOK signal is modulated, to indicate different information by transmitting different sequences.

There may be different receiver types for a control signal of the foregoing waveform:
a receiver of a type 1, which can demodulate only an ON/OFF signal but cannot detect a specific OFDM-modulated sequence of a modulated ON signal;
a receiver of a type 2, which can demodulate an ON/OFF signal and detect a specific OFDM-modulated sequence of a modulated ON signal;
a receiver of a type 3, which has a capability of demodulating an on-off keying signal but not of detecting a complex signal sequence; and
a receiver of a type 4, which has a capability of detecting a complex signal sequence.

The receivers of the foregoing types 2, 3, and 4 have a stronger demodulation capability, and performance/coverage of the receivers is generally better than that of the receiver of the type 1.

Performance of the receivers of the types 1, 2, 3, and 4 are generally poorer than that of a receiver of a main communication module, and measurement precision of the receivers of the types 1, 2, 3, and 4 is also lower than or equal to measurement precision of the receiver of the main communication module. To ensure mobility performance of a terminal, radio resource management (RRM) measurement needs to be performed by a primary receiver in a case that a condition of a channel is poor. How to accurately perform RRM measurement switching between a primary receiver and a low power receiver is an urgent problem to be solved.

### SUMMARY

Embodiments of this application provide a measurement switching method and apparatus, an information transmission method and apparatus, a terminal, and a network side device, to accurately perform RRM measurement switching between a primary receiver and a low power receiver.

According to a first aspect, a measurement switching method is provided. The method is executed by a terminal, and includes:
obtaining, by a terminal, a first measurement result corresponding to a first measurement behavior; and
determining, by the terminal based on the first measurement result and a measurement switching threshold, whether to switch to a second measurement behavior.

The measurement switching threshold is related to a type of a low power receiver of the terminal and/or a signal type measured by a low power receiver.

According to a second aspect, a measurement switching apparatus is provided. The apparatus is applied to a terminal, and includes:
a first obtaining module, configured to obtain a first measurement result corresponding to a first measurement behavior; and
a determining module, configured to determine, based on the first measurement result and a measurement switching threshold, whether to switch to a second measurement behavior.

The measurement switching threshold is related to a type of a low power receiver of the terminal and/or a signal type measured by a low power receiver.

According to a third aspect, an information transmission method is provided. The method is executed by a network side device, and includes:
notifying, by a network side device, a terminal of a measurement switching threshold corresponding to at least one type of low power receiver;
notifying, by a network side device, a terminal of a measurement switching threshold corresponding to a combination of at least one type of low power receiver and a signal type measured by the terminal by using the low power receiver, where the signal type measured by the low power receiver includes at least one of the following: a synchronization signal block (SSB), an on signal or an off signal of an on-off keying signal of a low power synchronization signal (LP-SS), or a modulation sequence signal in an on-off keying signal of an LP-SS; or
notifying, by a network side device, a terminal of a measurement switching threshold corresponding to at least one signal type measured by a low power receiver, where the signal type measured by the low power receiver includes at least one of the following: an SSB or an LP-SS.

According to a fourth aspect, an information transmission apparatus is provided. The apparatus is applied to a network side device, and includes:
a notification module, configured to: notify a terminal of a measurement switching threshold corresponding to at least one type of low power receiver;
notify a terminal of a measurement switching threshold corresponding to a combination of at least one type of low power receiver and a signal type measured by the terminal by using the low power receiver, where the signal type measured by the low power receiver includes at least one of the following: a synchronization signal block (SSB), an on signal or an off signal of an on-off keying signal of a low power synchronization signal (LP-SS), or a modulation sequence signal in an on-off keying signal of an LP-SS; or
notify a terminal of a measurement switching threshold corresponding to at least one signal type measured by a low power receiver, where the signal type measured by the low power receiver includes at least one of the following: an SSB or an LP-SS.

According to a fifth aspect, a terminal is provided. The terminal includes a processor and a memory. The memory stores a program or instructions capable of running on the processor, and the steps of the method according to the first aspect are implemented when the program or instructions are executed by the processor.

According to a sixth aspect, a terminal is provided. The terminal includes a processor and a communication interface. The processor is configured to obtain a first measurement result corresponding to a first measurement behavior, and determine, based on the first measurement result and a measurement switching threshold, whether to switch to a second measurement behavior.

The measurement switching threshold is related to a type of a low power receiver of the terminal and/or a signal type measured by a low power receiver.

According to a seventh aspect, a network side device is provided. The network side device includes a processor and a memory. The memory stores a program or instructions capable of running on the processor, and the steps of the method according to the third aspect are implemented when the program or instructions are executed by the processor.

According to an eighth aspect, a network side device is provided, including a processor and a communication interface. The communication interface is configured to:
notify a terminal of a measurement switching threshold corresponding to at least one type of low power receiver;
notify a terminal of a measurement switching threshold corresponding to a combination of at least one type of low power receiver and a signal type measured by the terminal by using the low power receiver, where the signal type measured by the low power receiver includes at least one of the following: a synchronization signal block (SSB), an on signal or an off signal of an on-off keying signal of a low power synchronization signal (LP-SS), or a modulation sequence signal in an on-off keying signal of an LP-SS; or
notify a terminal of a measurement switching threshold corresponding to at least one signal type measured by a low power receiver, where the signal type measured by the low power receiver includes at least one of the following: an SSB or an LP-SS.

According to a ninth aspect, a communication system is provided, including a terminal and a network side device, where the terminal may be configured to perform the steps of the method according to the first aspect, and the network side device may be configured to perform the steps of the method according to the third aspect.

According to a tenth aspect, a readable storage medium is provided. The readable storage medium stores a program or instructions, and the steps of the method according to the first aspect or the third aspect are implemented when the program or instructions are executed by a processor.

According to an eleventh aspect, a chip is provided. The chip includes a processor and a communication interface. The communication interface is coupled to the processor. The processor is configured to run a program or instructions to implement the steps of the method according to the first aspect or the third aspect.

According to a twelfth aspect, a computer program/program product is provided. The computer program/program product is stored in a storage medium, and the computer program/program product is executed by at least one processor to implement the steps of the method according to the first aspect or the third aspect.

In embodiments of this application, whether to switch to the second measurement behavior is determined based on the first measurement result corresponding to the first measurement behavior and the measurement switching threshold related to the type of the low power receiver. In this way, measurement behavior switching can be accurately performed based on the type of the low power receiver, to achieve a reasonable balance between different measurement precision and low power consumption.

### BRIEF DESCRIPTION OF DRAWINGS

FIG. 1 is a block diagram of a wireless communication system to which an embodiment of this application is applicable;

FIG. 2 is a schematic diagram of a working principle of an NR LP-WUR/WUS;

FIG. 3 is a schematic diagram of on-off keying signal distribution;

FIG. 4 is a schematic diagram of a sending manner of an OOK signal;

FIG. 5 is a schematic flowchart of a measurement switching method according to an embodiment of this application;

FIG. 6 is a schematic flowchart of an information transmission method according to an embodiment of this application;

FIG. 7 is a schematic diagram of modules of a measurement switching apparatus according to an embodiment of this application;

FIG. 8 is a schematic diagram of a structure of a terminal according to an embodiment of this application;

FIG. 9 is a schematic diagram of a module of an information transmission apparatus according to an embodiment of this application;

FIG. 10 is a schematic diagram of a structure of a network side device according to an embodiment of this application; and

FIG. 11 is a schematic diagram of a structure of a communication device according to an embodiment of this application.

### DESCRIPTION OF EMBODIMENTS

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on embodiments of this application shall fall within the protection scope of this application.

The terms “first”, “second”, and the like in this application are used to distinguish between similar objects instead of describing a specified order or sequence. It should be understood that terms used in this way are interchangeable under appropriate circumstances, so that the embodiments of this application can be implemented in a sequence other than that illustrated or described herein. Moreover, the terms “first” and “second” typically distinguish between objects of one category rather than limiting a quantity of objects. For example, there may be one or more first objects. In addition, “or” in this application represents at least one of connected objects. For example, “A or B” includes three solutions, that is, a solution 1: including A and not including B; a solution 2: including B and not including A; and a solution 3: including both A and B. The character “/” generally represents an “or” relationship between associated objects.

The term “indication” in this application may be either a direct indication (or an explicit indication) or an indirect indication (or an implicit indication). The direct indication may be understood as: A sender explicitly notifies, in a sent indication, a receiver of specific information, an operation that needs to be performed, a requested result, or other content. The indirect indication may be understood as: The receiver determines corresponding information based on the indication sent by the sender, or performs determining based on the indication sent by the sender, and determines, based on a determining result, the operation that needs to be performed or the requested result.

It should be noted that a technology described in the embodiments of this application is not limited to a long term evolution (LTE)/LTE-advanced (LTE-A) system, and may be further applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency-division multiple access (SC-FDMA) system, or another system. The terms “system” and “network” are often used interchangeably in the embodiments of this application. The technology described may be used for the systems and radio technologies described above, as well as other systems and radio technologies. The following describes a new radio (NR) system for illustrative purposes, and NR terms are used in most of the following descriptions. However, these technologies are also applicable to systems such as a 6th generation (6G) communication system other than the NR system.

FIG. 1 is a block diagram of a wireless communication system to which an embodiment of this application is applicable. The wireless communication system includes a terminal 11 and a network side device 12. The terminal 11 may be a mobile phone, a tablet personal computer, a laptop computer, a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device (Wearable Device), a flight vehicle, vehicle user equipment (VUE), ship-mounted equipment, pedestrian user equipment (PUE), a smart home (a home device with a wireless communication function, for example, a refrigerator, a television, a laundry machine, or a furniture), a gaming console, a personal computer (PC), a teller machine, a self-service machine, or another terminal side device. The wearable device includes a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in this embodiment of this application. The network side device 12 may include an access network device or a core network device. The access network device may also be referred to as a radio access network (RAN) device, a radio access network function, or a radio access network unit. The access network device may include a base station, a wireless local area network (WLAN) access point (AP), a wireless fidelity (WiFi) node, and the like. The base station may be referred to as a NodeB (NB), an evolved NodeB (eNB), the next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another proper term in the field. The base station is not limited to a specific technical term, provided that a same technical effect is achieved. It should be noted that in the embodiments of this application, only a base station in an NR system is used as an example for description, and a specific type of the base station is not limited.

The following first describes the technologies related to embodiments of this application.

### I. Low Power Receiver

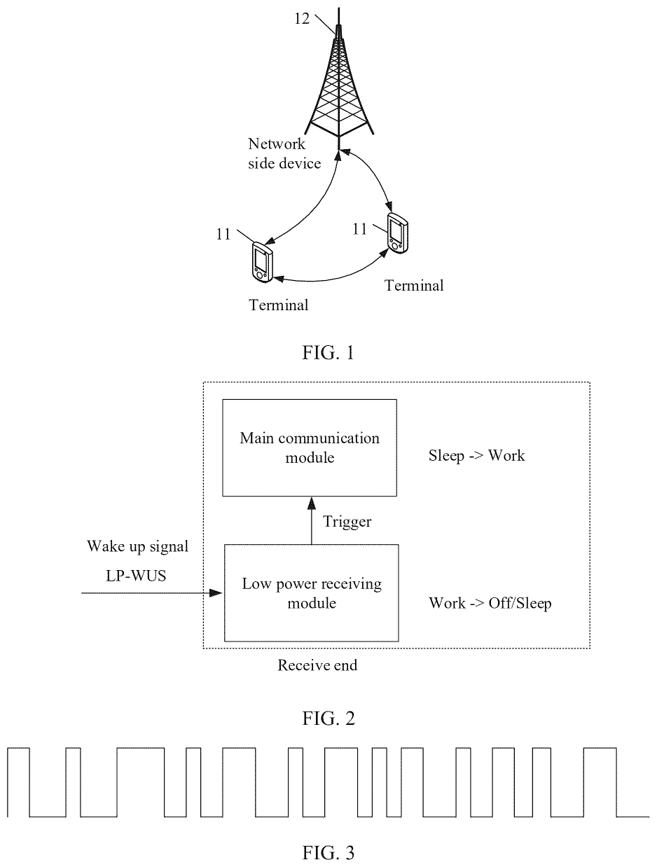

The 3rd generation partnership project (3GPP) will start to introduce the study of low power wake up receivers (LP WUR)/low power wake up signals (LP-WUS) in mobile cellular systems from Rel-18. A basic working principle of an LP WUR is that a receive end includes a first module and a second module. Specifically, as shown in FIG. 2, the first module is a main communication module, and is configured to send and receive mobile communication data. The second module is a low power wake up receiving module, and is configured to receive the foregoing wake up signal. In an energy-saving state, a terminal enables the low power receiving module to monitor the LP-WUS, and disables the main communication module. When downlink data arrives, a network sends a wake up signal to the terminal. After detecting the wake up signal by using the low power receiving module, the terminal triggers the main communication module after a series of determining, to change from a disabled state to an enabled state (in this case, the low power receiving module enters the disabled state from a working state). The low power wake up receiving module may be continuously enabled or intermittently enabled, and may receive a low power wake up signal when being enabled.

### II. LP-WUS or Almost Zero Power Wake Up Signal (AZP-WUS)

To reduce receiving activities of a terminal in a standby state, so that a radio frequency (RF) module and a baseband (MODEM) module are truly disabled, and communication receiving power consumption is greatly reduced, an almost “zero” power receiver may be introduced into a receiving module of the terminal. The almost “zero” power receiver does not require complex signal detection (such as amplification, filtering, and quantization) by the RF module and signal processing by the modem, and can only depend on passive matched filtering and low power signal processing.

On a base station side, a wake up signal is triggered on-demand, so that the almost “zero” power receiver can be activated to learn of an activation advertisement, thereby triggering a series of procedures inside the terminal, for example, enabling a radio frequency transceiver module and a baseband processing module.

Usually, the wake up signal is a relatively simple on-off keying (OOK) signal. As shown in FIG. 3, the receiver can learn of a wake up advertisement by using a process such as simple energy detection and subsequent possible sequence detection and identification.

In a new radio (NR) system in a related art, an orthogonal frequency division multiplexing (OFDM) signal modulation manner is usually used. In this way, an OOK signal may be generated in an OFDM signal generation manner, for example, ON/OFF in a time domain is represented by sending or not sending an OFDM-modulated sequence. The OOK signal may be received by using a low power receiver, but reception performance of such a receiver is poor and coverage is also poor.

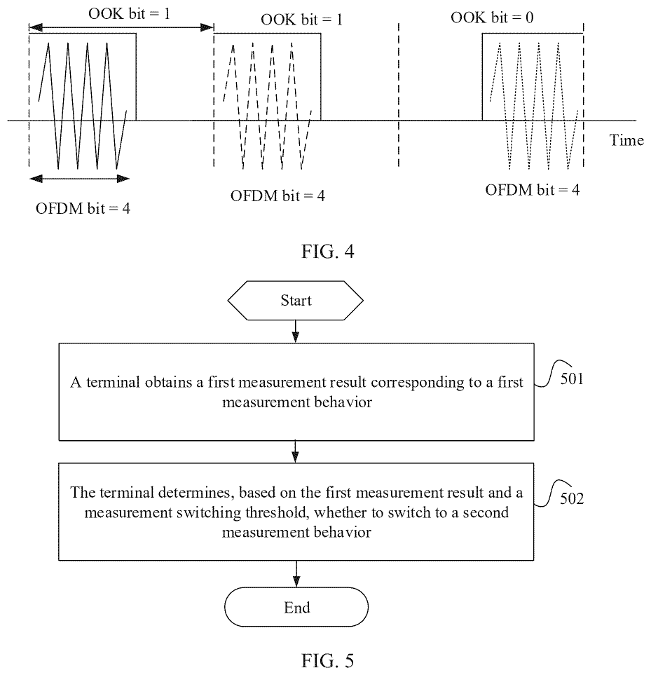

Further, the OFDM-modulated sequence modulated to “ON” may further carry information by using different sequences, for example, two sequences respectively represent information 0 and 1 or four sequences respectively represent information 00, 01, 10, and 11. As shown in FIG. 4, some information is modulated through OOK, and the other information is carried by an OFDM sequence at an ON level.

An OFDM sequence needs to be demodulated by using a receiver having an OFDM signal reception capability. Generally, demodulation performance of such a receiver is better than that of a low power receiver that can demodulate only an OOK signal.

### III. Measurement Behavior of NR System

A measurement behavior requirement of an NR system in a related art includes: A terminal is required to periodically perform RRM measurement. RRM measurement is measurement performed using a primary receiver based on a synchronization signal/physical broadcast channel signal block (or Synchronization Signal and PBCH block, SSB).

In a case of an introduced LP-WUR, the terminal may not need to periodically receive a paging physical downlink control channel (PDCCH), but periodic measurement still needs to use the primary receiver. In this case, overall power consumption of the terminal cannot be reduced. Therefore, a power saving gain brought by the introduction of the LP-WUR is limited.

However, precision of radio resource management (RRM) measurement performed by the low power receiver is relatively low. In a case that a condition of a channel is poor, power consumption of the low power receiver during RRM measurement is greatly reduced. Therefore, to achieve a better balance between low power consumption and measurement precision, different measurement behaviors need to be used based on signal conditions to achieve a reasonable balance between different measurement precision and low power consumption.

With reference to the accompanying drawings, a measurement switching method and apparatus, an information transmission method and apparatus, a terminal, and a network side device provided in embodiments of this application are described below in detail by using some embodiments and application scenarios thereof.

As shown in FIG. 5, an embodiment of this application provides a measurement switching method, including the following steps.

Step 501: A terminal obtains a first measurement result corresponding to a first measurement behavior.

Step 502: The terminal determines, based on the first measurement result and a measurement switching threshold, whether to switch to a second measurement behavior.

The measurement switching threshold is related to a type of a low power receiver of the terminal and/or a signal type measured by a low power receiver.

It should be noted that whether to switch to the second measurement behavior is determined based on the first measurement result corresponding to the first measurement behavior and the measurement switching threshold related to the type of the low power receiver. In this way, measurement behavior switching can be accurately performed based on the type of the low power receiver, to achieve a reasonable balance between different measurement precision and low power consumption.

Optionally, in an implementation, the first measurement behavior or the second measurement behavior includes at least one of the following:
A11: Use the low power receiver to perform measurement.
A12: Use the low power receiver to perform measurement and use a receiver of a main communication module to perform measurement of a first period.

A13: Use a receiver of a main communication module to perform measurement of a second period.

The second period is less than the first period.

It should be noted herein that using of the receiver of the main communication module to perform measurement of the first period may be understood as using the receiver of the main communication module to perform relaxed periodic measurement, and using of the receiver of the main communication module to perform measurement of the second period may be understood as using the receiver of the main communication module to perform conventional periodic measurement or non-relaxed periodic measurement. It can be learned that power consumption of using the receiver of the main communication module to perform measurement of the first period is lower than that of using the receiver of the main communication module to perform measurement of the second period.

It should be noted that switching in this embodiment of this application may include: switching from A11 to A12, switching from A11 to A13, switching from A12 to A13, switching from A13 to A12, switching from A13 to A11, and switching from A12 to A11. Measurement switching thresholds corresponding to different switching processes are usually different. For example, a measurement switching threshold corresponding to switching from A11 to A13 is TH13, and a measurement switching threshold corresponding to switching from A13 to A11 is TH31, where TH13 is different from TH31.

It should be noted that, based on the foregoing measurement behaviors, the measurement behaviors may be classified into switching from a low power measurement behavior to a high power measurement behavior and switching from a high power measurement behavior to a low power measurement behavior, for example, switching from A11 to A12 and switching from A11 to A13. Switching from A12 to A13 may be considered as switching from a low power measurement behavior to a high power measurement behavior, and switching from A13 to A12, switching from A13 to A11, and switching from A12 to A11 each may be considered as switching from a high power measurement behavior to a low power measurement behavior.

For example, in a case of switching from a high power measurement behavior to a low power measurement behavior, if the first measurement result is higher than or equal to the measurement switching threshold, it is determined to switch to the second measurement behavior; or if the first measurement result is lower than the measurement switching threshold, it is determined to not switch to the second measurement behavior and continue to maintain the first measurement behavior. It may be understood as that a measurement result is good, which means that coverage is good, there is no need to use the high power measurement behavior, and the high power measurement behavior is switched to the low power measurement behavior. Alternatively, in a case of switching from a low power measurement behavior to a high power measurement behavior, if the first measurement result is lower than or equal to the measurement switching threshold, it is determined to switch to the second measurement behavior; or if the first measurement result is higher than the measurement switching threshold, it is determined to not switch to the second measurement behavior and continue to maintain the first measurement behavior. It may be understood as that a measurement result is poor, which means that coverage is poor, a measured value is low, and switching to the high power measurement behavior needs to be performed to improve measurement precision if the first measurement result is lower than the threshold.

Optionally, in an implementation, the method further includes at least one of the following:
A21: Listen for a low power wake up signal in a case of using the low power receiver to perform measurement.

In other words, regardless of the first measurement behavior or the second measurement behavior, the terminal needs to monitor the low power wake up signal if the terminal uses the low power receiver to perform measurement.
A22: Listen for a paging PDCCH or a paging early indication (PEI) PDCCH in a case of using the receiver of the main communication module to perform measurement.

In other words, regardless of the first measurement behavior or the second measurement behavior, the terminal needs to monitor the paging PDCCH or the PEI PDCCH if the terminal uses the receiver of the main communication module to perform measurement.

Further, measurement behavior switching is monitoring behavior switching. For example, monitoring the low power wake up signal by using the low power receiver is considered as a monitoring behavior 1, and monitoring the paging PDCCH or the PEI PDCCH by using the receiver of the main communication module is considered as a monitoring behavior 2. The monitoring behavior 1 is used if the first measurement result is higher than the measurement switching threshold, and the monitoring behavior 2 is used if the first measurement result is lower than the measurement switching threshold.

For example, in a case that the measurement result of the low power receiver is lower than a measurement switching threshold A, it indicates that channel quality is poor, and performance of the terminal in monitoring the low power wake up signal by using the low power receiver also becomes poor. In this case, the receiver of the main communication module may be used to directly monitor the paging PDCCH or the PEI PDCCH, to ensure paging reliability. Otherwise, in a case that the measurement result of the receiver of the main communication module is higher than a measurement switching threshold B, it indicates that channel quality is good, and detection performance can be ensured even if the terminal monitors the low power wake up signal by using the low power receiver. In this case, the low power receiver is used to monitor the low power wake up signal, thereby reducing power consumption of monitoring while ensuring performance.

It should be noted that for different receiver types, the measurement switching threshold may be different, and may be separately configured. Because measurement precision of different receiver types is different, the measurement switching threshold is also different. In this way, channel quality can be more accurately determined.

Optionally, in an implementation, the method further includes at least one of the following:
A31: Determine, if the first measurement result is higher than or equal to the measurement switching threshold, that the receiver of the main communication module uses a third period for measurement.

A32: Determine, if the first measurement result is lower than the measurement switching threshold, that the receiver of the main communication module uses a fourth period for measurement.

The third period is greater than or equal to the fourth period.

It may be understood herein that if the receiver of the main communication module is used after switching, it is required to determine, based on a relationship between the first measurement result and the measurement switching threshold, a period used by the receiver of the main communication module. If the first measurement result measured by the low power receiver is higher than or equal to the measurement switching threshold, channel quality is good, and the receiver of the main communication module may use a long period for measurement, that is, the measurement does not need to be too frequent, and measurement relaxation may be performed. If the first measurement result is lower than the measurement switching threshold, channel quality is poor, and the receiver of the main communication module uses a short period for measurement, to ensure measurement accuracy, that is, measurement relaxation is not performed or measurement of a long period is performed.

Optionally, the third period and the fourth period may have a same concept as the foregoing first period, except that a period length is different.

It should be noted that for different receiver types, the measurement switching threshold may be different, and may be separately configured. Because measurement precision of different receiver types is different, the switching threshold is also different. In this way, channel quality can be more accurately determined.

Optionally, in an implementation, the type of the low power receiver includes at least one of the following:
B11 of having a capability of demodulating an on-off keying (OOK) signal but not of detecting a modulation sequence of a modulated on (ON) signal.

It should be noted that this type may be understood as the receiver of the type 1, that is, a low power receiver of this type can demodulate only the on-off keying signal but cannot detect the modulation sequence of the modulated on signal, or may be understood as that a low power receiver of this type has the capability of demodulating only an on-off keying signal but not of detecting a modulation sequence of a modulated on signal.
B12 of having a capability of demodulating an on-off keying signal and detecting a modulation sequence of a modulated on signal.

It should be noted that this type may be understood as the receiver of the type 2, that is, a low power receiver of this type can demodulate the on-off keying signal and detect the modulation sequence of the modulated on signal, or may be understood as that a low power receiver of this type has the capability of demodulating an on-off keying signal and detecting a modulation sequence of a modulated on signal.
B13 of having a capability of demodulating an on-off keying signal but not of detecting a complex signal sequence.

It should be noted that this type may be understood as the receiver of the type 3, that is, a low power receiver of this type can demodulate the on-off keying signal, but cannot detect the complex signal sequence.

B14 of having a capability of detecting a complex signal sequence.

It should be noted that this type may be understood as the receiver of the type 4, that is, a low power receiver of this type can detect the complex signal sequence.

Optionally, in an implementation, the having a capability of detecting a complex signal sequence includes having a capability of demodulating an on-off keying signal and detecting a complex signal sequence.

Optionally, in an implementation, the complex signal sequence includes at least one of the following: a time-domain complex signal sequence or a frequency-domain complex signal sequence. From a perspective of a transmit end, the complex signal sequence may be a signal sequence defined in a time domain or a frequency domain. From a perspective of a receive end, the complex signal sequence is detected in a time domain, that is, the receive end may complete detection of the complex signal sequence in the time domain without a fast Fourier transform (FFT) capability.

Optionally, the modulation sequence includes a complex sequence determined based on at least one of the following or a sequence determined by multiplying real or complex values generated based on at least two of the following:
an M sequence, a ZC sequence, a gold sequence, a constant amplitude zero auto-correlation (CAZAC) sequence, or a sequence generated by a constellation point corresponding to a first modulation manner.

The first modulation manner includes at least one of the following: binary phase shift keying (BPSK) modulation, pi/2 BPSK modulation, quadrature phase shift keying (QPSK) modulation, 16-symbol quadrature amplitude modulation (16QAM), 64-symbol quadrature amplitude modulation (64QAM), 256-symbol quadrature amplitude modulation (256QAM), 1024-symbol quadrature amplitude modulation (1024QAM), or 4096-symbol quadrature amplitude modulation (4096QAM).

Optionally, the constellation point mentioned above refers to a quadrature amplitude modulation symbol, that is, the quadrature amplitude modulation symbol is the constellation point. For example, 16QAM modulation can generate 16 modulation symbols, and these 16 modulation symbols can also be referred to as constellation points corresponding to the 16QAM modulation manner.

It may be understood that the modulation sequence may be the complex sequence generated based on the M sequence, the ZC sequence, the gold sequence, the CAZAC sequence, or the sequence generated by the constellation point corresponding to the first modulation manner. Alternatively, the modulation sequence may be the sequence generated by multiplying the real or complex values generated based on at least two of the M sequence, the ZC sequence, the gold sequence, the CAZAC sequence, or the sequence generated by the constellation point corresponding to the first modulation manner.

Optionally, the complex signal sequence includes a complex sequence determined based on at least one of the following or a sequence determined by multiplying real or complex values generated based on at least two of the following:
an M sequence, a ZC sequence, a gold sequence, a constant amplitude zero auto-correlation CAZAC sequence, or a sequence generated by a constellation point corresponding to a second modulation manner.

The second modulation manner includes at least one of the following: BPSK modulation, pi/2 BPSK modulation, QPSK modulation, 16QAM, 64QAM, 256QAM, 1024QAM, or 4096QAM.

It may be understood that the complex signal sequence may be the complex sequence generated based on the M sequence, the ZC sequence, the gold sequence, the CAZAC sequence, or the sequence generated by the constellation point corresponding to the second modulation manner. Alternatively, the complex signal sequence may be the sequence generated by multiplying the real or complex values generated based on at least two of the M sequence, the ZC sequence, the gold sequence, the CAZAC sequence, or the sequence generated by the constellation point corresponding to the second modulation manner.

It should be noted that an OFDM signal modulation manner is usually used in an NR system in a related art. In this way, an OOK signal may be generated in an OFDM signal generation manner, for example, ON/OFF in a time domain is represented by sending or not sending an OFDM-modulated sequence. The OOK signal may be received by using a low power receiver, but reception performance of such a receiver is poor and coverage is also poor. Further, the OFDM-modulated sequence modulated to ON may further carry information by using different sequences, for example, two sequences respectively represent information 0 and 1 or four sequences respectively represent information 00, 01, 10, and 11, as shown in FIG. 4. In FIG. 4, some information is modulated through OOK, and the other information is carried by an OFDM sequence at an ON level. An OFDM sequence needs to be demodulated by using a receiver having an OFDM signal reception capability. Generally, demodulation performance of such a receiver is better than that of a low power receiver that can demodulate only an OOK signal. There may be different low power receiver types for a control signal of the foregoing waveform, for example, low power receivers of the foregoing types 1, 2, 3, and 4. For RRM measurement, because the receiver of the type 2 or the type 4 has a stronger capability, and higher measurement precision than that of the receiver of the type 1 or the type 3, when switching is performed between the low power receiver and the receiver of the main communication module for RRM measurement, the type of the low power receiver needs to be considered, that is, the measurement switching threshold is determined separately based on capabilities of demodulating different waveforms. In addition, precision of measurement performed by the receiver of the type 2 or the type 4 based on an OFDM signal sequence of a modulated on-off keying signal is different from precision of measurement performed by the receiver of the type 4 based on a signal sequence in a synchronization signal block SSB. Usually, precision of measurement performed by the low power receiver based on a PSS/SSS in the SSB is higher than that of measurement performed based on the OFDM signal sequence of the modulated on-off keying signal, for example, a higher precision requirement is defined or there is a precision requirement for measurement based on the PSS/SSS but there is no precision requirement for measurement based on the OFDM signal sequence of the modulated on-off keying signal. Therefore, when switching is performed between the low power receiver and the receiver of the main communication module for RRM measurement, a measured signal type further needs to be considered, that is, the measurement switching threshold is determined separately based on signals used for measurement. Although an OFDM receiver performs measurement using an LP-SS with an overlaid OFDM sequence, RAN4 does not define a requirement for this measurement method, and thus performance cannot be ensured. In this case, using the measurement switching threshold for the OOK signal enables a more accurate switching behavior of user equipment (UE), thereby ensuring measurement performance.

Optionally, measurement based on the signal sequence in the SSB and measurement based on the OFDM signal sequence of the modulated on-off keying signal require different receiver capabilities.

For example, a measurement switching threshold corresponding to switching from A11 to A13 is TH13-1 for the low power receiver of the type 1, a measurement switching threshold corresponding to switching from A11 to A13 is TH13-2 for the low power receiver of the type 2, a measurement switching threshold corresponding to switching from A13 to A11 is TH31-1 for the low power receiver of the type 1, and a measurement switching threshold corresponding to switching from A13 to A11 is TH31-2 for the low power receiver of the type 2, where TH13-1 is different from TH31-1, TH13-2 is different from TH31-2, TH13-1 is different from TH13-2, and TH31-1 is different from TH31-2.

It should be noted that, to enable the terminal to normally use the measurement switching threshold, optionally, in an implementation, the method further includes at least one of the following:
C1: Obtain a measurement switching threshold corresponding to at least one type of low power receiver.
C2: Obtain a measurement switching threshold corresponding to a combination of at least one type of low power receiver and a signal type measured by the terminal by using the low power receiver.

It should be noted that the signal type measured by the low power receiver includes at least one of the following:
a synchronization signal block (SSB);
an on signal or an off signal of an on-off keying signal of a low power synchronization signal (LP-SS); or
a modulation sequence signal in an on-off keying signal of an LP-SS.
C3: Obtain a measurement switching threshold corresponding to at least one signal type measured by the low power receiver.

It should be noted that the signal type measured by the low power receiver in this case includes one of the following: an SSB or an LP-SS. Optionally, the LP-SS includes at least one of the following: an on signal or an off signal of an on-off keying signal of the LP-SS or a modulation sequence signal in an on-off keying signal of the LP-SS.

Optionally, the measurement switching threshold may be specified in a protocol or configured by a network side device.

Further, optionally, in a case that the measurement switching threshold is configured by the network side device, in an implementation, obtaining of the measurement switching threshold corresponding to the at least one type of low power receiver includes at least one of the following:
C11: Receive a plurality of measurement switching thresholds sent by a network side device, where one measurement switching threshold corresponds to one type of low power receiver.

For example, the network side device sends two thresholds TH13-1 and TH13-2, where TH13-1 corresponds to the low power receiver of the type 1 and TH13-2 corresponds to the low power receiver of the type 2/4.

It should be noted that, in this case, it may be understood that the network side device separately configures a measurement switching threshold corresponding to each type of low power receiver, and measurement switching thresholds corresponding to types of different low power receivers may be the same or different.

Optionally, the network side device may send the plurality of measurement switching thresholds to the terminal through broadcasting, or may send the plurality of measurement switching thresholds to the terminal by using terminal-specific signaling.
C12: The terminal receives corresponding threshold configuration information based on this type of low power receiver, where the threshold configuration information includes the measurement switching threshold.

It should be noted that, in this case, the network side device separately configures one piece of threshold configuration information for each type of low power receiver, to indicate a measurement switching threshold corresponding to this type of low power receiver.
C13: Receive a threshold offset value and a measurement switching threshold corresponding to a type of a first low power receiver that are sent by a network side device, and obtain a measurement switching threshold corresponding to a type of a second low power receiver based on the threshold offset value and the measurement switching threshold corresponding to the type of the first low power receiver.

It should be noted that, in this case, during configuration, the network side device configures only a measurement switching threshold corresponding to one type of low power receiver, and a measurement switching threshold corresponding to another type of low power receiver is configured based on an offset value thereof relative to the measurement switching threshold corresponding to the given type of low power receiver.

Optionally, the threshold offset value and the measurement switching threshold corresponding to the type of the first low power receiver may be sent by the network side device through broadcasting or by using terminal-specific signaling.

It should be noted that the terminal may simultaneously implement different types of low power receivers, that is, low power receiver types that have a plurality of different capabilities. In this way, the terminal determines a used switching threshold based on a type of a low power receiver actually used in this case. The terminal may implement a same type of low power receiver with a capability of measuring a plurality of signal types. For example, the low power receiver of the type 4 has a capability of measuring an SSB and measuring an OFDM signal sequence of a modulated on-off keying signal, i.e., LP-SS. In this way, the terminal determines a used switching threshold based on a signal type actually used for measurement in this case. Optionally, if the terminal generates a measurement value based on a plurality of signal types, for example, combines measurement values based on the SSB and the OFDM signal sequence of the modulated on-off keying signal, the terminal determines a used switching threshold based on one of the pre-defined signal types. For example, when a measurement signal is an SSB, a corresponding switching threshold is used.

Further, optionally, in a case that the measurement switching threshold is configured by the network side device, in an implementation, obtaining of the measurement switching threshold corresponding to the combination of the at least one type of low power receiver and the signal type measured by the terminal by using the low power receiver includes at least one of the following:
C21: The terminal receives a plurality of measurement switching thresholds sent by a network side device, where one measurement switching threshold corresponds to one type of low power receiver and one signal type measured by the low power receiver of the terminal.

It should be noted that, in this case, it may be understood as that the network side device separately configures a measurement switching threshold corresponding to a combination of each type of low power receiver and a signal type measured by the low power receiver of the terminal, and measurement switching thresholds corresponding to combinations of different types of low power receivers and signal types measured by the low power receivers may be the same or different.

Optionally, the network side device may send the plurality of measurement switching thresholds to the terminal through broadcasting, or may send the plurality of measurement switching thresholds to the terminal by using terminal-specific signaling.

For example, the network side device sends three thresholds TH13-1, TH13-2, and TH13-3, where TH13-1 corresponds to the low power receiver of the type 1, TH13-2 corresponds to the low power receiver of the type 2 or type 4 whose measurement is based on the OFDM signal sequence of the modulated on-off keying signal, and TH13-3 corresponds to the low power receiver of the type 4 whose measurement is based on the signal sequence in the SSB.
C22: The terminal obtains corresponding threshold configuration information based on the type of the low power receiver and the signal type measured by the low power receiver, where the threshold configuration information includes the measurement switching threshold.

It should be noted that, in this case, the network side device separately configures one piece of threshold configuration information for a combination of each type of low power receiver and a signal type measured by the low power receiver, to indicate a measurement switching threshold corresponding to the combination of this type of low power receiver and the signal type measured by the low power receiver.
C23: The terminal receives a threshold offset value and a measurement switching threshold corresponding to a type of a first low power receiver and a signal type measured by the first low power receiver that are sent by a network side device, and obtains, based on the threshold offset value and the measurement switching threshold corresponding to the type of the first low power receiver and the signal type measured by the first low power receiver, a measurement switching threshold corresponding to a type of a second low power receiver and a signal type measured by the second low power receiver.

It should be noted that, in this case, during configuration, the network side device configures only a measurement switching threshold corresponding to a combination of one type of low power receiver and a signal type measured by the low power receiver, and a measurement switching threshold corresponding to a combination of another type of low power receiver and a signal type measured by the another low power receiver is configured based on an offset value thereof relative to the measurement switching threshold corresponding to the combination of the given type of low power receiver and the signal type measured by the low power receiver.

Optionally, the threshold offset value and the measurement switching threshold corresponding to the type of the first low power receiver and the signal type measured by the first low power receiver may be sent by the network side device through broadcasting or by using terminal-specific signaling.

It should be noted that the terminal may simultaneously implement low power receivers of different types and measurement of different signal types, that is, has a capability of implementing low power receiver types with a plurality of different capabilities and receiving different signal types. In this way, the terminal determines a used switching threshold based on a type of a low power receiver actually used in this case and a signal type measured by the low power receiver. The terminal may implement a same type of low power receiver with a capability of measuring a plurality of signal types. For example, the low power receiver of the type 4 has a capability of measuring an SSB and measuring an OFDM signal sequence of a modulated on-off keying signal. In this way, the terminal determines a used switching threshold based on a signal type actually used for measurement in this case. Optionally, if the terminal generates a measurement value based on a plurality of signal types, for example, combines measurement values based on the SSB and the OFDM signal sequence of the modulated on-off keying signal, the terminal determines a used switching threshold based on one of the pre-defined signal types. For example, when a measurement signal is an SSB, a corresponding switching threshold is used.

Further, optionally, in a case that the measurement switching threshold is configured by the network side device, in an implementation, obtaining of the measurement switching threshold corresponding to the at least one signal type measured by the low power receiver includes at least one of the following:
C31: The terminal receives a plurality of measurement switching thresholds sent by a network side device, where one measurement switching threshold corresponds to one signal type measured by the low power receiver.

It should be noted that, in this case, it may be understood that the network side device separately configures a measurement switching threshold corresponding to each signal type measured by the low power receiver, and measurement switching thresholds corresponding to different signal types measured by the low power receiver may be the same or different.

Optionally, the network side device may send the plurality of measurement switching thresholds to the terminal through broadcasting, or may send the plurality of measurement switching thresholds to the terminal by using terminal-specific signaling.

For example, the network side device sends two thresholds TH13-1 and TH13-2, where TH13-1 corresponds to the low power receiver of the type 1 and the low power receiver of the type 2 or type 4 whose measurement is based on the OFDM signal sequence of the modulated on-off keying signal. TH13-2 corresponds to the low power receiver of the type 4 whose measurement is based on the signal sequence in the SSB.
C32: The terminal receives corresponding threshold configuration information based on the signal type measured by the low power receiver, where the threshold configuration information includes the measurement switching threshold.

It should be noted that, in this case, the network side device separately configures one piece of threshold configuration information for each signal type measured by the low power receiver, to indicate a measurement switching threshold corresponding to this signal type measured by the low power receiver.
C33: The terminal receives a threshold offset value and a measurement switching threshold corresponding to a first signal type measured by the low power receiver that are sent by a network side device, and obtains, based on the threshold offset value and the measurement switching threshold corresponding to the first signal type measured by the low power receiver, a measurement switching threshold corresponding to a second signal type measured by the low power receiver.

It should be noted that, in this case, during configuration, the network side device configures only a measurement switching threshold corresponding to one signal type, and a measurement switching threshold corresponding to another signal type is configured based on an offset value thereof relative to the measurement switching threshold corresponding to the given signal type.

Optionally, the threshold offset value and the measurement switching threshold corresponding to the signal type may be sent by the network side device through broadcasting or by using terminal-specific signaling.

It should be noted that the terminal may implement a capability of simultaneously measuring a plurality of signal types. In this way, the terminal determines a used switching threshold based on a signal type actually measured in this case. The terminal may implement a same type of low power receiver with a capability of measuring a plurality of signal types. For example, the low power receiver of the type 4 has a capability of measuring an SSB and measuring an OFDM signal sequence of a modulated on-off keying signal. In this way, the terminal determines a used switching threshold based on a signal type actually used for measurement in this case. Optionally, if the terminal generates a measurement value based on a plurality of signal types, for example, combines measurement values based on the SSB and the OFDM signal sequence of the modulated on-off keying signal, the terminal determines a used switching threshold based on one of the pre-defined signal types. For example, when a measurement signal is an SSB, a corresponding switching threshold is used.

Optionally, in an implementation, in a case that the first measurement behavior includes using the low power receiver to perform measurement and using the receiver of the main communication module to perform measurement of the first period, the first measurement result is obtained by at least one of the following:
D11: Use the low power receiver to perform measurement.

Optionally, in this case, an obtained measurement value includes at least one of the following:
D111: A measurement value corresponding to an on signal or an off signal of an on-off keying signal.
D112: A measurement value corresponding to an orthogonal frequency division multiplexing OFDM signal sequence.

The OFDM signal sequence may be a sequence modulated on an on-off keying signal or a signal sequence in an SSB, for example, a PSS and/or an SSS.

It should be noted that the measurement value mentioned in this embodiment of this application includes at least one of the following: reference signal received power (RSRP), reference signal received quality (RSRQ), or a signal-to-noise and interference ratio (SINR).

It may be understood that a measurement result refers to a measurement value.
D12: Use the receiver of the main communication module to perform measurement.

It should be noted that the first measurement result may be any one of D11 or D12, or may be obtained through calculation of D11 and D12, for example, determined based on a weighted sum of D11 and D12.

Optionally, in an implementation, a measurement resource of the receiver of the main communication module includes at least one of the following:
E11: An SSB.
E12: A channel state information reference signal (CSI-RS).

Optionally, in an implementation, in a case that the first measurement behavior includes using the low power receiver to perform measurement, the first measurement result is obtained by at least one of the following:
F11: A measurement value corresponding to an on signal or an off signal of an on-off keying signal.
F12: A measurement value corresponding to an orthogonal frequency division multiplexing OFDM signal sequence.

The OFDM signal sequence may be a sequence modulated on an on-off keying signal or a signal sequence in an SSB, for example, a PSS and/or an SSS.

Optionally, RRM measurement corresponding to the first measurement behavior includes at least one of the following:
serving cell measurement, camping cell measurement, intra-frequency measurement, or inter-frequency measurement.

It should be further noted herein that a measurement signal measured by the terminal is sent by the network side device. Optionally, the network side device generates a measurement signal in a first manner and sends the measurement signal to the terminal. The first manner includes at least one of the following:
H11: Modulate an on-off keying signal based on whether to send an OFDM signal sequence.

It should be noted that in this case, both the low power receivers of the type 1 and the type 2 can demodulate the measurement signal.
H12: Carry a modulated on-off keying signal by using different OFDM signal sequences.

It should be noted that in this case, only the low power receiver of the type 2 can detect the measurement signal.
H13: Determine an on-off keying signal as the measurement signal.

It should be noted that in this case, the on-off keying signal is sent to the terminal as the measurement signal.

Optionally, in this case, all the low power receivers of the type 1, the type 2, the type 3, and the type 4 can demodulate the measurement signal.
H14: Generate an on-off keying signal by generating a plurality of on or off (ON/OFF) states within duration of one OFDM symbol.

Optionally, in this case, only the low power receivers of the type 2 and the type 4 can detect the measurement signal.
H15: Generate an on-off keying signal in one OFDM symbol by using different OFDM signal sequences.

Optionally, there may be one or more on-off keying signals in one OFDM symbol.

Optionally, in this case, only the low power receivers of the type 2 and the type 4 can detect the measurement signal.
H16: Determine a synchronization signal block or a target reference signal in a synchronization signal block as the measurement signal, where the target reference signal includes a primary synchronization signal (PSS) or a secondary synchronization signal (SSS).

Optionally, in this case, only the low power receiver of the type 4 can detect the measurement signal.

The following describes a specific application of this application by using an example.

The RRM measurement behavior switching mentioned in this embodiment of this application mainly includes switching in two directions: 1. Switching from a low power measurement behavior to a high power measurement behavior. 2. Switching from a high power measurement behavior to a low power measurement behavior. In the foregoing measurement behaviors A11-A13, A11 and A12 are measurement behaviors with low power consumption, and A13 is a measurement behavior with high power consumption. Measurement precision of a low power measurement behavior is relatively low because a low power receiver is used. However, measurement precision is relatively high because reception reliability of a high power receiver is higher.

There are different types of low power receivers, which correspond to different reception reliability and measurement precision. In the two types of low power receivers in this embodiment of this application, reliability and measurement precision of the low power receiver of the type 2 are higher than those of the low power receiver of the type 1. For two low power receivers with different measurement precision, measurement switching thresholds for RRM measurement should also be different. Different switching thresholds may be set for types of different low power receivers, to ensure that the terminal achieves, when using the low power receiver, a better balance between saving power consumption and ensuring reliability of RRM measurement.

Switching from the measurement behavior corresponding to A11 to the measurement behavior corresponding to A13 is used as an example. A measurement threshold of a measurement behavior is determined based on the type of the low power receiver. For example, a measurement switching threshold for switching from the measurement behavior corresponding to A11 to the measurement behavior corresponding to A13 includes at least one of the following:
a) A measurement switching threshold TH13_1 corresponding to the low power receiver of the type 1.
b) A measurement switching threshold TH13_2 corresponding to the low power receiver of the type 2.

TH13_1 and TH13_2 may be separately configured by the network side device based on the types of the low power receivers. Alternatively, the network side device configures a threshold offset value DELTA_13 and the measurement switching threshold corresponding to the type of one of the low power receivers, and the terminal may determine, based on the threshold offset value and the measurement switching threshold corresponding to the type of the low power receiver, the measurement switching threshold corresponding to the type of the other low power receiver. For example, the network side device configures TH13_1 and DELTA_13, and then the terminal may determine TH13_2 based on TH13_1 and DELTA_13.

For switching from the measurement behavior corresponding to A13 to the measurement behavior corresponding to A11, a measurement threshold of a measurement behavior is determined based on the type of the low power receiver. For example, a measurement switching threshold for switching from the measurement behavior corresponding to A13 to the measurement behavior corresponding to A11 includes at least one of the following:
a) A measurement switching threshold TH31_1 corresponding to the low power receiver of the type 1.
b) A measurement switching threshold TH31_2 corresponding to the low power receiver of the type 2.

TH31_1 and TH31_2 may be separately configured by the network side device based on the types of the low power receivers. Alternatively, the network side device configures a threshold offset value DELTA_31 and the measurement switching threshold corresponding to the type of one of the low power receivers, and the terminal may determine, based on the threshold offset value and the measurement switching threshold corresponding to the type of the low power receiver, the measurement switching threshold corresponding to the type of the other low power receiver. For example, the network side device configures TH31_1 and DELTA_31, and then the terminal may determine TH31_2 based on TH31_1 and DELTA_31.

It should be noted that the low power receiver has different capabilities or there are different types of low power receivers, which correspond to different reception reliability and measurement precision. In at least one embodiment of this application, considering that in the two types of low power receivers, reliability and measurement precision of the low power receiver of the type 2 are higher than those of the low power receiver of the type 1, measurement switching thresholds used for RRM measurement of the two receivers with different measurement precision should also be different. Therefore, different measurement switching thresholds may be set for types of different low power receivers, to ensure that the terminal achieves, when using the low power receiver, a better balance between saving power consumption and ensuring reliability of RRM measurement.

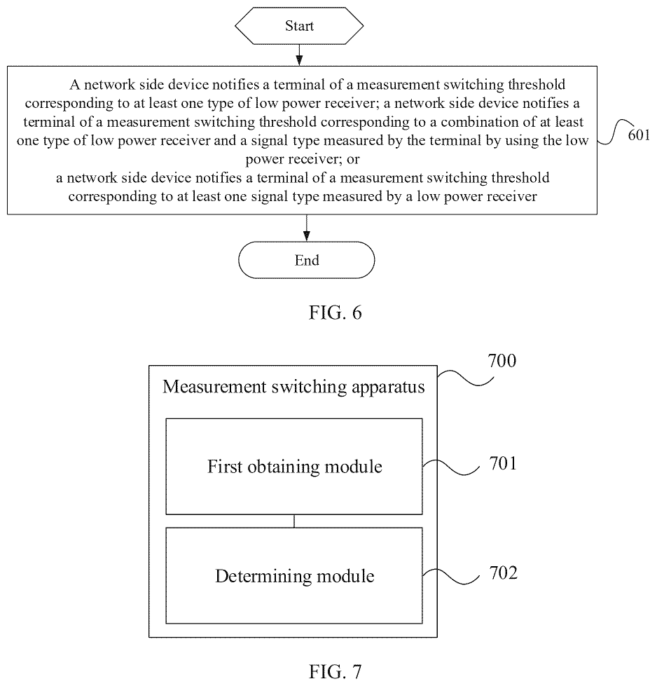

For an implementation on a terminal side, as shown in FIG. 6, an embodiment of this application provides an information transmission method, including the following step.

Step 601: A network side device notifies a terminal of a measurement switching threshold corresponding to at least one type of low power receiver;
a network side device notifies a terminal of a measurement switching threshold corresponding to a combination of at least one type of low power receiver and a signal type measured by the terminal by using the low power receiver, where the signal type measured by the low power receiver includes at least one of the following: a synchronization signal block SSB, an on signal or an off signal of an on-off keying signal of a low power synchronization signal LP-SS, or a modulation sequence signal in an on-off keying signal of an LP-SS; or
a network side device notifies a terminal of a measurement switching threshold corresponding to at least one signal type measured by a low power receiver, where the signal type measured by the low power receiver includes at least one of the following: an SSB or an LP-SS.

Optionally, in a case that the signal type measured by the low power receiver is the LP-SS, the LP-SS includes at least one of the following: an on signal or an off signal of an on-off keying signal of the LP-SS or a modulation sequence signal in an on-off keying signal of the LP-SS.

Optionally, that a network side device notifies a terminal of a measurement switching threshold corresponding to at least one type of low power receiver includes:
sending a plurality of measurement switching thresholds to the terminal, where one measurement switching threshold corresponds to one type of low power receiver;
sending threshold configuration information corresponding to the type of the low power receiver to the terminal, where the threshold configuration information includes the measurement switching threshold; or
sending a threshold offset value and a measurement switching threshold corresponding to a type of a first low power receiver to the terminal, where the threshold offset value is used to indicate an offset between a measurement switching threshold of a type of a second low power receiver and the measurement switching threshold corresponding to the type of the first low power receiver.

Optionally, that a network side device notifies a terminal of a measurement switching threshold corresponding to a combination of at least one type of low power receiver and a signal type measured by the terminal by using the low power receiver includes at least one of the following:
The network side device sends a plurality of measurement switching thresholds to the terminal, where one measurement switching threshold corresponds to one type of low power receiver and one signal type measured by the low power receiver of the terminal;
the network side device sends threshold configuration information corresponding to the type of the low power receiver and the signal type measured by the low power receiver to the terminal, where the threshold configuration information includes the measurement switching threshold; or
the network side device sends a threshold offset value and a measurement switching threshold corresponding to a type of a first low power receiver and a signal type measured by the first low power receiver to the terminal, where the threshold offset value is used to indicate an offset between a measurement switching threshold corresponding to a type of a second low power receiver and a signal type measured by the second low power receiver and the measurement switching threshold corresponding to the type of the first low power receiver and the signal type measured by the first low power receiver.

Optionally, that a network side device notifies a terminal of a measurement switching threshold corresponding to at least one signal type measured by a low power receiver includes at least one of the following:
The network side device sends a plurality of measurement switching thresholds to the terminal, where one measurement switching threshold corresponds to one signal type measured by the low power receiver;
the network side device sends threshold configuration information corresponding to the signal type measured by the low power receiver to the terminal, where the threshold configuration information includes the measurement switching threshold; or
the network side device sends a threshold offset value and a measurement switching threshold corresponding to a first signal type measured by the low power receiver to the terminal, where the threshold offset value is used to indicate an offset between a measurement switching threshold corresponding to a second signal type measured by the low power receiver and the measurement switching threshold corresponding to the first signal type measured by the low power receiver.

Optionally, the method further includes:
generating a measurement signal in a first manner; and
sending the measurement signal.

The first manner includes at least one of the following:
determining an on-off keying signal as the measurement signal;
modulating an on-off keying signal based on whether to send an orthogonal frequency division multiplexing OFDM signal sequence;
generating an on-off keying signal by generating a plurality of on or off states within duration of one OFDM symbol;
carrying a modulated on-off keying signal by using different OFDM signal sequences;
generating an on-off keying signal in one OFDM symbol by using different OFDM signal sequences; or
determining a synchronization signal block or a target reference signal in a synchronization signal block as the measurement signal, where the target reference signal includes a primary synchronization signal PSS or a secondary synchronization signal SSS.

It should be noted that all descriptions of the network side device side in the foregoing embodiments are applicable to the embodiments of the information transmission method applied to the network side device side, and a same technical effect can also be achieved. Details are not described herein again.

The measurement switching method provided in the embodiments of this application may be performed by a measurement switching apparatus. In an embodiment of this application, a measurement switching apparatus provided in an embodiment of this application is described by using an example in which the measurement switching apparatus performs the measurement switching method.

As shown in FIG. 7, a measurement switching apparatus 700 in an embodiment of this application is applied to a terminal, and includes:
a first obtaining module 701, configured to obtain a first measurement result corresponding to a first measurement behavior; and
a determining module 702, configured to determine, based on the first measurement result and a measurement switching threshold, whether to switch to a second measurement behavior.

The measurement switching threshold is related to a type of a low power receiver of the terminal and/or a signal type measured by a low power receiver.

Optionally, the first measurement behavior or the second measurement behavior includes at least one of the following:
using the low power receiver to perform measurement;
using the low power receiver to perform measurement and using a receiver of a main communication module to perform measurement of a first period; or
using a receiver of a main communication module to perform measurement of a second period.

The second period is less than the first period.

Optionally, the apparatus further includes at least one of the following:
a first monitoring module, configured to monitor a low power wake up signal in a case of using the low power receiver to perform measurement; or
a second monitoring module, configured to monitor a paging physical downlink control channel PDCCH or a paging early indication PDCCH in a case of using the receiver of the main communication module to perform measurement.

Optionally, the apparatus further includes at least one of the following:
a first determining module, configured to determine, if the first measurement result is higher than or equal to the measurement switching threshold, that the receiver of the main communication module uses a third period for measurement; or
a second determining module, configured to determine, if the first measurement result is lower than the measurement switching threshold, that the receiver of the main communication module uses a fourth period for measurement.

The third period is greater than or equal to the fourth period.

Optionally, the type of the low power receiver includes at least one of the following:
having a capability of demodulating an on-off keying signal but not of detecting a modulation sequence of a modulated on signal;
having a capability of demodulating an on-off keying signal and detecting a modulation sequence of a modulated on signal;
having a capability of demodulating an on-off keying signal but not of detecting a complex signal sequence; or
having a capability of detecting a complex signal sequence.

Optionally, the having a capability of detecting a complex signal sequence includes having a capability of demodulating an on-off keying signal and detecting a complex signal sequence.

Optionally, the modulation sequence includes a complex sequence determined based on at least one of the following or a sequence determined by multiplying real or complex values generated based on at least two of the following:
an M sequence, a ZC sequence, a gold sequence, a constant amplitude zero auto-correlation CAZAC sequence, or a sequence generated by a constellation point corresponding to a first modulation manner.

The first modulation manner includes at least one of the following: binary phase shift keying (BPSK) modulation, pi/2 BPSK modulation, quadrature phase shift keying (QPSK) modulation, 16-symbol quadrature amplitude modulation (16QAM), 64-symbol quadrature amplitude modulation (64QAM), 256-symbol quadrature amplitude modulation (256QAM), 1024-symbol quadrature amplitude modulation (1024QAM), or 4096-symbol quadrature amplitude modulation (4096QAM).

Optionally, the complex signal sequence includes a complex sequence determined based on at least one of the following or a sequence determined by multiplying real or complex values generated based on at least two of the following:
an M sequence, a ZC sequence, a gold sequence, a constant amplitude zero auto-correlation CAZAC sequence, or a sequence generated by a constellation point corresponding to a second modulation manner.

The second modulation manner includes at least one of the following: BPSK modulation, pi/2 BPSK modulation, QPSK modulation, 16QAM, 64QAM, 256QAM, 1024QAM, or 4096QAM.

Optionally, the apparatus further includes:
a second obtaining module, configured to obtain a measurement switching threshold corresponding to at least one type of low power receiver.

Optionally, the second obtaining module is configured to implement at least one of the following:
receiving a plurality of measurement switching thresholds sent by a network side device, where one measurement switching threshold corresponds to one type of low power receiver;
receiving corresponding threshold configuration information based on the type of the low power receiver, where the threshold configuration information includes the measurement switching threshold; or
receiving a threshold offset value and a measurement switching threshold corresponding to a type of a first low power receiver that are sent by a network side device, and obtaining a measurement switching threshold corresponding to a type of a second low power receiver based on the threshold offset value and the measurement switching threshold corresponding to the type of the first low power receiver.

Optionally, the apparatus further includes:
a third obtaining module, configured to obtain a measurement switching threshold corresponding to a combination of at least one type of low power receiver and a signal type measured by the terminal by using the low power receiver.

The signal type measured by the low power receiver includes at least one of the following:
a synchronization signal block (SSB);
an on signal or an off signal of an on-off keying signal of a low power synchronization signal (LP-SS); or
a modulation sequence signal in an on-off keying signal of an LP-SS.

Optionally, the third obtaining module is configured to implement at least one of the following:
receiving a plurality of measurement switching thresholds sent by a network side device, where one measurement switching threshold corresponds to one type of low power receiver and one signal type measured by the low power receiver of the terminal;
obtaining corresponding threshold configuration information based on the type of the low power receiver and the signal type measured by the low power receiver, where the threshold configuration information includes the measurement switching threshold; or
receiving a threshold offset value and a measurement switching threshold corresponding to a type of a first low power receiver and a signal type measured by the first low power receiver that are sent by a network side device, and obtaining, based on the threshold offset value and the measurement switching threshold corresponding to the type of the first low power receiver and the signal type measured by the first low power receiver, a measurement switching threshold corresponding to a type of a second low power receiver and a signal type measured by the second low power receiver.

Optionally, a specific implementation of obtaining the corresponding threshold configuration information based on the type of the low power receiver and the signal type measured by the low power receiver includes at least one of the following:
determining, if the signal type measured by the terminal is the SSB and the low power receiver of the terminal has a capability of detecting a modulation sequence of a modulated on signal or detecting a complex signal sequence, that the corresponding threshold is a threshold corresponding to the low power receiver;
determining, if the signal type measured by the terminal is the modulation sequence signal in the on-off keying signal of the LP-SS and the low power receiver of the terminal has a capability of detecting a modulation sequence of a modulated on signal or detecting a complex signal sequence, that the corresponding threshold is a threshold corresponding to a target low power receiver, where the target low power receiver does not have the capability of detecting a modulation sequence of a modulated on signal or does not have the capability of detecting a complex signal sequence; or
determining, if the signal type measured by the terminal is the on signal or the off signal of the on-off keying signal of the LP-SS and the low power receiver of the terminal does not have a capability of detecting a modulation sequence of a modulated on signal or detecting a complex signal sequence, that the corresponding threshold is a threshold corresponding to the low power receiver.

Optionally, the apparatus further includes:
a fourth obtaining module, configured to obtain a measurement switching threshold corresponding to at least one signal type measured by the low power receiver.

The signal type measured by the low power receiver includes at least one of the following:
an SSB; or
an LP-SS.

Optionally, the fourth obtaining module is configured to implement at least one of the following:
receiving a plurality of measurement switching thresholds sent by a network side device, where one measurement switching threshold corresponds to one signal type measured by the low power receiver;
receiving corresponding threshold configuration information based on the signal type measured by the low power receiver, where the threshold configuration information includes the measurement switching threshold; or
receiving a threshold offset value and a measurement switching threshold corresponding to a first signal type measured by the low power receiver that are sent by a network side device, and obtaining, based on the threshold offset value and the measurement switching threshold corresponding to the first signal type measured by the low power receiver, a measurement switching threshold corresponding to a second signal type measured by the low power receiver.

Optionally, in a case that the signal type measured by the low power receiver is the LP-SS, the LP-SS includes at least one of the following: an on signal or an off signal of an on-off keying signal of the LP-SS or a modulation sequence signal in an on-off keying signal of the LP-SS.

Optionally, in a case that the first measurement behavior includes using the low power receiver to perform measurement and using the receiver of the main communication module to perform measurement of the first period, the first measurement result is obtained by at least one of the following:
using the low power receiver to perform measurement; or
using the receiver of the main communication module to perform measurement.

Optionally, a measurement resource of the receiver of the main communication module includes at least one of the following:
a synchronization signal block (SSB); or
a channel state information reference signal (CSI-RS).

Optionally, a measurement value obtained by performing measurement by using the low power receiver includes at least one of the following:
a measurement value corresponding to an on signal or an off signal of an on-off keying signal; or
a measurement value corresponding to an orthogonal frequency division multiplexing (OFDM) signal sequence.

Optionally, RRM measurement corresponding to the first measurement behavior includes at least one of the following:
serving cell measurement, camping cell measurement, intra-frequency measurement, or inter-frequency measurement.

It should be noted that the apparatus embodiment shows an apparatus corresponding to the foregoing method, all implementations in the foregoing method embodiment are applicable to the apparatus embodiment, and a same technical effect can also be achieved. Details are not described herein again.

The measurement switching apparatus in this embodiment of this application may be an electronic device, for example, an electronic device with an operating system, or may be a component in an electronic device, for example, an integrated circuit or a chip. The electronic device may be a terminal, or may be another device different from a terminal. For example, the terminal may include but is not limited to the foregoing listed types of the terminal 11. The another device may be a server, a network attached storage (NAS), or the like. This is not specifically limited in this embodiment of this application.

An embodiment of this application further provides a terminal, including a processor and a communication interface. The processor is configured to obtain a first measurement result corresponding to a first measurement behavior, and determine, based on the first measurement result and a measurement switching threshold, whether to switch to a second measurement behavior.

The measurement switching threshold is related to a type of a low power receiver of the terminal and/or a signal type measured by a low power receiver.

Optionally, the first measurement behavior or the second measurement behavior includes at least one of the following:
using the low power receiver to perform measurement;
using the low power receiver to perform measurement and using a receiver of a main communication module to perform measurement of a first period; or
using a receiver of a main communication module to perform measurement of a second period.

The second period is less than the first period.

Optionally, the communication interface is configured to implement at least one of the following:
monitoring a low power wake up signal in a case of using the low power receiver to perform measurement; or
monitoring a paging physical downlink control channel (PDCCH) or a paging early indication PDCCH in a case of using the receiver of the main communication module to perform measurement.

Optionally, the processor is further configured to implement at least one of the following:
determining, if the first measurement result is higher than or equal to the measurement switching threshold, that the receiver of the main communication module uses a third period for measurement; or
determining, if the first measurement result is lower than the measurement switching threshold, that the receiver of the main communication module uses a fourth period for measurement.

The third period is greater than or equal to the fourth period.

Optionally, the type of the low power receiver includes at least one of the following:
having a capability of demodulating an on-off keying signal but not of detecting a modulation sequence of a modulated on signal;
having a capability of demodulating an on-off keying signal and detecting a modulation sequence of a modulated on signal;
having a capability of demodulating an on-off keying signal but not of detecting a complex signal sequence; or
having a capability of detecting a complex signal sequence.

Optionally, the modulation sequence includes a complex sequence determined based on at least one of the following or a sequence determined by multiplying real or complex values generated based on at least two of the following:
an M sequence, a ZC sequence, a gold sequence, a constant amplitude zero auto-correlation (CAZAC) sequence, or a sequence generated by a constellation point corresponding to a first modulation manner.

The first modulation manner includes at least one of the following: binary phase shift keying (BPSK) modulation, pi/2 BPSK modulation, quadrature phase shift keying (QPSK) modulation, 16-symbol quadrature amplitude modulation (16QAM), 64-symbol quadrature amplitude modulation (64QAM), 256-symbol quadrature amplitude modulation (256QAM), 1024-symbol quadrature amplitude modulation (1024QAM), or 4096-symbol quadrature amplitude modulation (4096QAM).

Optionally, the complex signal sequence includes a complex sequence determined based on at least one of the following or a sequence determined by multiplying real or complex values generated based on at least two of the following:
an M sequence, a ZC sequence, a gold sequence, a constant amplitude zero auto-correlation (CAZAC) sequence, or a sequence generated by a constellation point corresponding to a second modulation manner.

The second modulation manner includes at least one of the following: BPSK modulation, pi/2 BPSK modulation, QPSK modulation, 16QAM, 64QAM, 256QAM, 1024QAM, or 4096QAM.

Optionally, the processor is further configured to:
obtain a measurement switching threshold corresponding to at least one type of low power receiver.

Optionally, the communication interface is configured to implement at least one of the following:
receiving a plurality of measurement switching thresholds sent by a network side device, where one measurement switching threshold corresponds to one type of low power receiver;
receiving corresponding threshold configuration information based on the type of the low power receiver, where the threshold configuration information includes the measurement switching threshold; or
receiving a threshold offset value and a measurement switching threshold corresponding to a type of a first low power receiver that are sent by a network side device, and obtaining a measurement switching threshold corresponding to a type of a second low power receiver based on the threshold offset value and the measurement switching threshold corresponding to the type of the first low power receiver.

Optionally, the processor is further configured to:
obtain a measurement switching threshold corresponding to a combination of at least one type of low power receiver and a signal type measured by the terminal by using the low power receiver.

The signal type measured by the low power receiver includes at least one of the following:
a synchronization signal block (SSB);
an on signal or an off signal of an on-off keying signal of a low power synchronization signal (LP-SS); or
a modulation sequence signal in an on-off keying signal of an LP-SS.

Optionally, the communication interface is configured to implement at least one of the following:
receiving a plurality of measurement switching thresholds sent by a network side device, where one measurement switching threshold corresponds to one type of low power receiver and one signal type measured by the low power receiver of the terminal;
obtaining corresponding threshold configuration information based on the type of the low power receiver and the signal type measured by the low power receiver, where the threshold configuration information includes the measurement switching threshold; or
receiving a threshold offset value and a measurement switching threshold corresponding to a type of a first low power receiver and a signal type measured by the first low power receiver that are sent by a network side device, and obtaining, based on the threshold offset value and the measurement switching threshold corresponding to the type of the first low power receiver and the signal type measured by the first low power receiver, a measurement switching threshold corresponding to a type of a second low power receiver and a signal type measured by the second low power receiver.

Optionally, the communication interface is configured to implement at least one of the following:
determining, if the signal type measured by the terminal is the SSB and the low power receiver of the terminal has a capability of detecting a modulation sequence of a modulated on signal or detecting a complex signal sequence, that the corresponding threshold is a threshold corresponding to the low power receiver;
determining, if the signal type measured by the terminal is the modulation sequence signal in the on-off keying signal of the LP-SS and the low power receiver of the terminal has a capability of detecting a modulation sequence of a modulated on signal or detecting a complex signal sequence, that the corresponding threshold is a threshold corresponding to a target low power receiver, where the target low power receiver does not have the capability of detecting a modulation sequence of a modulated on signal or does not have the capability of detecting a complex signal sequence; or
determining, if the signal type measured by the terminal is the on signal or the off signal of the on-off keying signal of the LP-SS and the low power receiver of the terminal does not have a capability of detecting a modulation sequence of a modulated on signal or detecting a complex signal sequence, that the corresponding threshold is a threshold corresponding to the low power receiver.

Optionally, the processor is further configured to:
obtain a measurement switching threshold corresponding to at least one signal type measured by the low power receiver.

The signal type measured by the low power receiver includes at least one of the following:
an SSB; or
an LP-SS.

Optionally, the communication interface is further configured to implement at least one of the following:
receiving a plurality of measurement switching thresholds sent by a network side device, where one measurement switching threshold corresponds to one signal type measured by the low power receiver;
receiving corresponding threshold configuration information based on the signal type measured by the low power receiver, where the threshold configuration information includes the measurement switching threshold; or
receiving a threshold offset value and a measurement switching threshold corresponding to a first signal type measured by the low power receiver that are sent by a network side device, and obtaining, based on the threshold offset value and the measurement switching threshold corresponding to the first signal type measured by the low power receiver, a measurement switching threshold corresponding to a second signal type measured by the low power receiver.

Optionally, in a case that the signal type measured by the low power receiver is the LP-SS, the LP-SS includes at least one of the following: an on signal or an off signal of an on-off keying signal of the LP-SS or a modulation sequence signal in an on-off keying signal of the LP-SS.

Optionally, in a case that the first measurement behavior includes using the low power receiver to perform measurement and using the receiver of the main communication module to perform measurement of the first period, the first measurement result is obtained by at least one of the following:
using the low power receiver to perform measurement; or
using the receiver of the main communication module to perform measurement.

Optionally, a measurement resource of the receiver of the main communication module includes at least one of the following:
a synchronization signal block (SSB); or
a channel state information reference signal (CSI-RS).

Optionally, a measurement value obtained by performing measurement by using the low power receiver includes at least one of the following:
a measurement value corresponding to an on signal or an off signal of an on-off keying signal; or
a measurement value corresponding to an orthogonal frequency division multiplexing (OFDM) signal sequence.

Optionally, RRM measurement corresponding to the first measurement behavior includes at least one of the following:
serving cell measurement, camping cell measurement, intra-frequency measurement, or inter-frequency measurement.

Optionally, an embodiment of this application further provides a terminal, including a processor, a memory, and a program or instructions that are stored in the memory and that may be run on the processor. The processes in the foregoing measurement switching method embodiment are implemented when the program or instructions are executed by the processor, and a same technical effect can be achieved. To avoid repetition, details are not described herein again. Specifically, FIG. 8 is a schematic diagram of a hardware structure of a terminal for implementing an embodiment of this application.

A terminal 800 includes but is not limited to at least some components in a radio frequency unit 801, a network module 802, an audio output unit 803, an input unit 804, a sensor 805, a display unit 806, a user input unit 807, an interface unit 808, a memory 809, a processor 810, and the like.

A person skilled in the art may understand that the terminal 800 may further include a power supply (for example, a battery) that supplies power to each component. The power supply may be logically connected to the processor 810 by using a power management system, so as to implement functions such as charging management, discharging management, and power consumption management by using the power management system. The structure of the terminal shown in FIG. 8 does not constitute a limitation on the terminal. The terminal may include more or fewer components than those shown in the figure, or combine some components, or have different component arrangements. Details are not described herein again.

It should be understood that in the embodiments of this application, the input unit 804 may include a graphics processing unit (GPU) 8041 and a microphone 8042. The graphics processing unit 8041 processes image data of a still picture or a video obtained by an image capture apparatus (for example, a camera) in a video capture mode or an image capture mode. The display unit 806 may include a display panel 8061, and the display panel 8061 may be configured in a form of a liquid crystal display, an organic light-emitting diode, or the like. The user input unit 807 includes at least one of a touch panel 8071 or another input device 8072. The touch panel 8071 is also referred to as a touchscreen. The touch panel 8071 may include two parts: a touch detection apparatus and a touch controller. The another input device 8072 may include but is not limited to a physical keyboard, a function key (for example, a volume control key or an on/off key), a trackball, a mouse, and a joystick. Details are not described herein.

In the embodiments of this application, after receiving downlink data from an access network device, the radio frequency unit 801 may transmit the downlink data to the processor 810 for processing. In addition, the radio frequency unit 801 may send uplink data to a network side device. Generally, the radio frequency unit 801 includes but is not limited to an antenna, an amplifier, a transceiver, a coupler, a low-noise amplifier, a duplexer, and the like.

The memory 809 may be configured to store a software program or instructions and various types of data. The memory 809 may mainly include a first storage area for storing a program or instructions and a second storage area for storing data. The first storage area may store an operating system, an application or instructions required by at least one function (for example, a sound play function or an image play function), and the like. In addition, the memory 809 may include a volatile memory or a nonvolatile memory, or the memory 809 may include both a volatile memory and a nonvolatile memory. The nonvolatile memory may be a read-only memory (ROM), a programmable read-only memory (PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), or a direct rambus random access memory (Direct Rambus RAM, DRRAM). The memory 809 in this embodiment of this application includes but is not limited to these memories and any other suitable type of memory.

The processor 810 may include one or more processing units. Optionally, the processor 810 is integrated with an application processor and a modem processor. The application processor mainly processes operations related to an operating system, a user interface, an application, and the like. The modem processor mainly processes a wireless communication signal, for example, a baseband processor. It may be understood that, the foregoing modem processor may not be integrated into the processor 810.

The processor 810 is configured to obtain a first measurement result corresponding to a first measurement behavior, and determine, based on the first measurement result and a measurement switching threshold, whether to switch to a second measurement behavior.

The measurement switching threshold is related to a type of a low power receiver of the terminal and/or a signal type measured by a low power receiver.

Optionally, the first measurement behavior or the second measurement behavior includes at least one of the following:
using the low power receiver to perform measurement;
using the low power receiver to perform measurement and using a receiver of a main communication module to perform measurement of a first period; or
using a receiver of a main communication module to perform measurement of a second period.

The second period is less than the first period.

Optionally, the radio frequency unit 801 is configured to implement at least one of the following:
monitoring a low power wake up signal in a case of using the low power receiver to perform measurement; or
monitoring a paging physical downlink control channel (PDCCH) or a paging early indication PDCCH in a case of using the receiver of the main communication module to perform measurement.

Optionally, the processor 810 is configured to implement at least one of the following:
determining, if the first measurement result is higher than or equal to the measurement switching threshold, that the receiver of the main communication module uses a third period for measurement; or
determining, if the first measurement result is lower than the measurement switching threshold, that the receiver of the main communication module uses a fourth period for measurement.

The third period is greater than or equal to the fourth period.

Optionally, the type of the low power receiver includes at least one of the following:
having a capability of demodulating an on-off keying signal but not of detecting a modulation sequence of a modulated on signal;
having a capability of demodulating an on-off keying signal and detecting a modulation sequence of a modulated on signal;
having a capability of demodulating an on-off keying signal but not of detecting a complex signal sequence; or
having a capability of detecting a complex signal sequence.

Optionally, the modulation sequence includes a complex sequence determined based on at least one of the following or a sequence determined by multiplying real or complex values generated based on at least two of the following:
an M sequence, a ZC sequence, a gold sequence, a constant amplitude zero auto-correlation (CAZAC) sequence, or a sequence generated by a constellation point corresponding to a first modulation manner.

The first modulation manner includes at least one of the following: binary phase shift keying (BPSK) modulation, pi/2 BPSK modulation, quadrature phase shift keying (QPSK) modulation, 16-symbol quadrature amplitude modulation (16QAM), 64-symbol quadrature amplitude modulation (64QAM), 256-symbol quadrature amplitude modulation (256QAM), 1024-symbol quadrature amplitude modulation (1024QAM), or 4096-symbol quadrature amplitude modulation (4096QAM).

Optionally, the complex signal sequence includes a complex sequence determined based on at least one of the following or a sequence determined by multiplying real or complex values generated based on at least two of the following:
an M sequence, a ZC sequence, a gold sequence, a constant amplitude zero auto-correlation (CAZAC) sequence, or a sequence generated by a constellation point corresponding to a second modulation manner.

The second modulation manner includes at least one of the following: BPSK modulation, pi/2 BPSK modulation, QPSK modulation, 16QAM, 64QAM, 256QAM, 1024QAM, or 4096QAM.

Optionally, the processor 810 is further configured to:
obtain a measurement switching threshold corresponding to at least one type of low power receiver.

Optionally, the radio frequency unit 801 is configured to implement at least one of the following:
receiving a plurality of measurement switching thresholds sent by a network side device, where one measurement switching threshold corresponds to one type of low power receiver;
receiving corresponding threshold configuration information based on the type of the low power receiver, where the threshold configuration information includes the measurement switching threshold; or
receiving a threshold offset value and a measurement switching threshold corresponding to a type of a first low power receiver that are sent by a network side device, and obtaining a measurement switching threshold corresponding to a type of a second low power receiver based on the threshold offset value and the measurement switching threshold corresponding to the type of the first low power receiver.

Optionally, the processor 810 is further configured to:
obtain a measurement switching threshold corresponding to a combination of at least one type of low power receiver and a signal type measured by the terminal by using the low power receiver.

The signal type measured by the low power receiver includes at least one of the following:
a synchronization signal block (SSB);
an on signal or an off signal of an on-off keying signal of a low power synchronization signal (LP-SS); or
a modulation sequence signal in an on-off keying signal of an LP-SS.

Optionally, the radio frequency unit 801 is configured to implement at least one of the following:
receiving a plurality of measurement switching thresholds sent by a network side device, where one measurement switching threshold corresponds to one type of low power receiver and one signal type measured by the low power receiver of the terminal;
obtaining corresponding threshold configuration information based on the type of the low power receiver and the signal type measured by the low power receiver, where the threshold configuration information includes the measurement switching threshold; or
receiving a threshold offset value and a measurement switching threshold corresponding to a type of a first low power receiver and a signal type measured by the first low power receiver that are sent by a network side device, and obtaining, based on the threshold offset value and the measurement switching threshold corresponding to the type of the first low power receiver and the signal type measured by the first low power receiver, a measurement switching threshold corresponding to a type of a second low power receiver and a signal type measured by the second low power receiver.

Optionally, the radio frequency unit 801 is configured to implement at least one of the following:
determining, if the signal type measured by the terminal is the SSB and the low power receiver of the terminal has a capability of detecting a modulation sequence of a modulated on signal or detecting a complex signal sequence, that the corresponding threshold is a threshold corresponding to the low power receiver;
determining, if the signal type measured by the terminal is the modulation sequence signal in the on-off keying signal of the LP-SS and the low power receiver of the terminal has a capability of detecting a modulation sequence of a modulated on signal or detecting a complex signal sequence, that the corresponding threshold is a threshold corresponding to a target low power receiver, where the target low power receiver does not have the capability of detecting a modulation sequence of a modulated on signal or does not have the capability of detecting a complex signal sequence; or
determining, if the signal type measured by the terminal is the on signal or the off signal of the on-off keying signal of the LP-SS and the low power receiver of the terminal does not have a capability of detecting a modulation sequence of a modulated on signal or detecting a complex signal sequence, that the corresponding threshold is a threshold corresponding to the low power receiver.

Optionally, the processor 810 is further configured to:
obtain a measurement switching threshold corresponding to at least one signal type measured by the low power receiver.

The signal type measured by the low power receiver includes at least one of the following:
an SSB; or
an LP-SS.

Optionally, the radio frequency unit 801 is further configured to implement at least one of the following:
receiving a plurality of measurement switching thresholds sent by a network side device, where one measurement switching threshold corresponds to one signal type measured by the low power receiver;
receiving corresponding threshold configuration information based on the signal type measured by the low power receiver, where the threshold configuration information includes the measurement switching threshold; or
receiving a threshold offset value and a measurement switching threshold corresponding to a first signal type measured by the low power receiver that are sent by a network side device, and obtaining, based on the threshold offset value and the measurement switching threshold corresponding to the first signal type measured by the low power receiver, a measurement switching threshold corresponding to a second signal type measured by the low power receiver.

Optionally, in a case that the signal type measured by the low power receiver is the LP-SS, the LP-SS includes at least one of the following: an on signal or an off signal of an on-off keying signal of the LP-SS or a modulation sequence signal in an on-off keying signal of the LP-SS.

Optionally, in a case that the first measurement behavior includes using the low power receiver to perform measurement and using the receiver of the main communication module to perform measurement of the first period, the first measurement result is obtained by at least one of the following:
using the low power receiver to perform measurement; or
using the receiver of the main communication module to perform measurement.

Optionally, a measurement resource of the receiver of the main communication module includes at least one of the following:
a synchronization signal block (SSB); or
a channel state information reference signal (CSI-RS).

Optionally, a measurement value obtained by performing measurement by using the low power receiver includes at least one of the following:
a measurement value corresponding to an on signal or an off signal of an on-off keying signal; or
a measurement value corresponding to an orthogonal frequency division multiplexing (OFDM) signal sequence.

Optionally, RRM measurement corresponding to the first measurement behavior includes at least one of the following:
serving cell measurement, camping cell measurement, intra-frequency measurement, or inter-frequency measurement.

Optionally, an embodiment of this application further provides a terminal, including a processor, a memory, and a program or instructions that are stored in the memory and that may be run on the processor. The processes in the foregoing measurement switching method embodiment are implemented when the program or instructions are executed by the processor, and a same technical effect can be achieved. To avoid repetition, details are not described herein again.

An embodiment of this application further provides a readable storage medium. The computer-readable storage medium stores a program or instructions. The processes in the foregoing measurement switching method embodiments are implemented when the program or instructions are executed by a processor, and a same technical effect can be achieved. To avoid repetition, details are not described herein again.

The computer-readable storage medium is, for example, a read-only memory (ROM for short), a random access memory (RAM for short), a magnetic disk, or an optical disc.

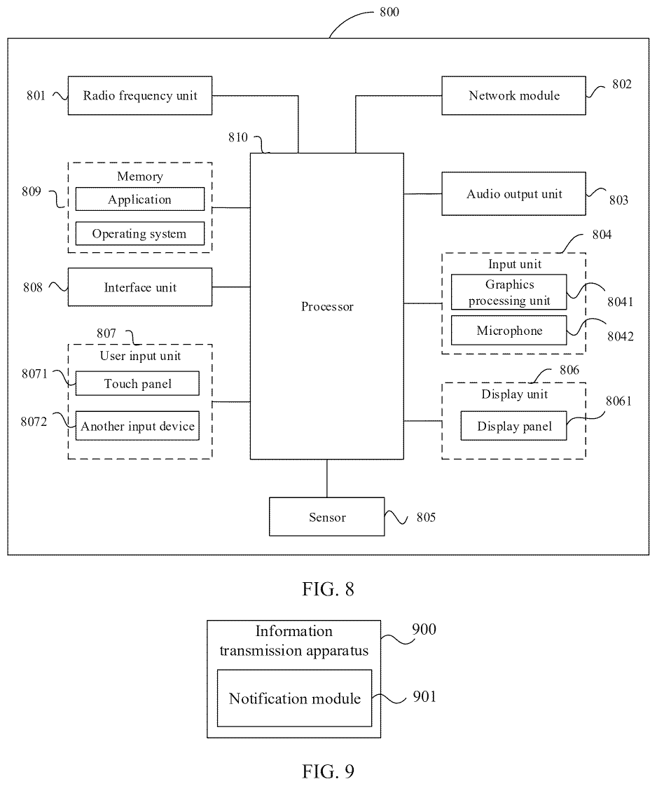

As shown in FIG. 9, an information transmission apparatus 900 of an embodiment of this application is applied to a network side device, and includes:
a notification module 901, configured to: notify a terminal of a measurement switching threshold corresponding to at least one type of low power receiver;
notify a terminal of a measurement switching threshold corresponding to a combination of at least one type of low power receiver and a signal type measured by the terminal by using the low power receiver, where the signal type measured by the low power receiver includes at least one of the following: a synchronization signal block (SSB), an on signal or an off signal of an on-off keying signal of a low power synchronization signal (LP-SS), or a modulation sequence signal in an on-off keying signal of an LP-SS; or
notify a terminal of a measurement switching threshold corresponding to at least one signal type measured by a low power receiver, where the signal type measured by the low power receiver includes at least one of the following: an SSB or an LP-SS.

Optionally, in a case that the signal type measured by the low power receiver is the LP-SS, the LP-SS includes at least one of the following: an on signal or an off signal of an on-off keying signal of the LP-SS or a modulation sequence signal in an on-off keying signal of the LP-SS.

Optionally, the notification module 901 is configured to implement at least one of the following:
sending a plurality of measurement switching thresholds to the terminal, where one measurement switching threshold corresponds to one type of low power receiver;
sending threshold configuration information corresponding to the type of the low power receiver to the terminal, where the threshold configuration information includes the measurement switching threshold; or
sending a threshold offset value and a measurement switching threshold corresponding to a type of a first low power receiver to the terminal, where the threshold offset value is used to indicate an offset between a measurement switching threshold of a type of a second low power receiver and the measurement switching threshold corresponding to the type of the first low power receiver.

Optionally, the notification module 901 is configured to implement at least one of the following:
sending a plurality of measurement switching thresholds to the terminal, where one measurement switching threshold corresponds to one type of low power receiver and one signal type measured by the low power receiver of the terminal;
sending threshold configuration information corresponding to the type of the low power receiver and the signal type measured by the low power receiver to the terminal, where the threshold configuration information includes the measurement switching threshold; or
sending a threshold offset value and a measurement switching threshold corresponding to a type of a first low power receiver and a signal type measured by the first low power receiver to the terminal, where the threshold offset value is used to indicate an offset between a measurement switching threshold corresponding to a type of a second low power receiver and a signal type measured by the second low power receiver and the measurement switching threshold corresponding to the type of the first low power receiver and the signal type measured by the first low power receiver.

Optionally, the notification module 901 is configured to implement at least one of the following:
sending a plurality of measurement switching thresholds to the terminal, where one measurement switching threshold corresponds to one signal type measured by the low power receiver;
sending threshold configuration information corresponding to the signal type measured by the low power receiver to the terminal, where the threshold configuration information includes the measurement switching threshold; or
sending a threshold offset value and a measurement switching threshold corresponding to a first signal type measured by the low power receiver to the terminal, where the threshold offset value is used to indicate an offset between a measurement switching threshold corresponding to a second signal type measured by the low power receiver and the measurement switching threshold corresponding to the first signal type measured by the low power receiver.

Optionally, the apparatus further includes:
a generation module, configured to generate a measurement signal in a first manner; and
a sending module, configured to send the measurement signal.

The first manner includes at least one of the following:
determining an on-off keying signal as the measurement signal;
modulating an on-off keying signal based on whether to send an orthogonal frequency division multiplexing (OFDM) signal sequence;
generating an on-off keying signal by generating a plurality of on or off states within duration of one OFDM symbol;
carrying a modulated on-off keying signal by using different OFDM signal sequences;
generating an on-off keying signal in one OFDM symbol by using different OFDM signal sequences; or
determining a synchronization signal block or a target reference signal in a synchronization signal block as the measurement signal, where the target reference signal includes a primary synchronization signal (PSS) or a secondary synchronization signal (SSS).

It should be noted that the apparatus embodiment corresponds to the foregoing method, all implementations in the foregoing method embodiment are applicable to the apparatus embodiment, and a same technical effect can also be achieved.

The information transmission apparatus provided in the embodiments of this application can implement processes implemented in the method embodiment shown in FIG. 6, and achieve the same technical effect. To avoid repetition, details are not described herein again.

An embodiment of this application further provides a network side device, including a processor and a communication interface. The communication interface is configured to notify a terminal of a measurement switching threshold corresponding to at least one type of low power receiver;
notify a terminal of a measurement switching threshold corresponding to a combination of at least one type of low power receiver and a signal type measured by the terminal by using the low power receiver, where the signal type measured by the low power receiver includes at least one of the following: a synchronization signal block (SSB), an on signal or an off signal of an on-off keying signal of a low power synchronization signal (LP-SS), or a modulation sequence signal in an on-off keying signal of an LP-SS; or

notify a terminal of a measurement switching threshold corresponding to at least one signal type measured by a low power receiver, where the signal type measured by the low power receiver includes at least one of the following: an SSB or an LP-SS.

Optionally, in a case that the signal type measured by the low power receiver is the LP-SS, the LP-SS includes at least one of the following: an on signal or an off signal of an on-off keying signal of the LP-SS or a modulation sequence signal in an on-off keying signal of the LP-SS.

Optionally, the communication interface is configured to implement at least one of the following:
sending a plurality of measurement switching thresholds to the terminal, where one measurement switching threshold corresponds to one type of low power receiver;
sending threshold configuration information corresponding to the type of the low power receiver to the terminal, where the threshold configuration information includes the measurement switching threshold; or
sending a threshold offset value and a measurement switching threshold corresponding to a type of a first low power receiver to the terminal, where the threshold offset value is used to indicate an offset between a measurement switching threshold of a type of a second low power receiver and the measurement switching threshold corresponding to the type of the first low power receiver.

Optionally, the communication interface is configured to implement at least one of the following:
sending a plurality of measurement switching thresholds to the terminal, where one measurement switching threshold corresponds to one type of low power receiver and one signal type measured by the low power receiver of the terminal;
sending threshold configuration information corresponding to the type of the low power receiver and the signal type measured by the low power receiver to the terminal, where the threshold configuration information includes the measurement switching threshold; or
sending a threshold offset value and a measurement switching threshold corresponding to a type of a first low power receiver and a signal type measured by the first low power receiver to the terminal, where the threshold offset value is used to indicate an offset between a measurement switching threshold corresponding to a type of a second low power receiver and a signal type measured by the second low power receiver and the measurement switching threshold corresponding to the type of the first low power receiver and the signal type measured by the first low power receiver.

Optionally, the communication interface is configured to implement at least one of the following:
sending a plurality of measurement switching thresholds to the terminal, where one measurement switching threshold corresponds to one signal type measured by the low power receiver;
sending threshold configuration information corresponding to the signal type measured by the low power receiver to the terminal, where the threshold configuration information includes the measurement switching threshold; or
sending a threshold offset value and a measurement switching threshold corresponding to a first signal type measured by the low power receiver to the terminal, where the threshold offset value is used to indicate an offset between a measurement switching threshold corresponding to a second signal type measured by the low power receiver and the measurement switching threshold corresponding to the first signal type measured by the low power receiver.

Optionally, the processor is configured to generate a measurement signal in a first manner.

The communication interface is configured to send the measurement signal.

The first manner includes at least one of the following:
determining an on-off keying signal as the measurement signal;
modulating an on-off keying signal based on whether to send an orthogonal frequency division multiplexing (OFDM) signal sequence;
generating an on-off keying signal by generating a plurality of on or off states within duration of one OFDM symbol;
carrying a modulated on-off keying signal by using different OFDM signal sequences;
generating an on-off keying signal in one OFDM symbol by using different OFDM signal sequences; or
determining a synchronization signal block or a target reference signal in a synchronization signal block as the measurement signal, where the target reference signal includes a primary synchronization signal (PSS) or a secondary synchronization signal (SSS).

The network side device embodiment corresponds to the foregoing method embodiment on the network side device side. Implementation processes and implementations of the foregoing method embodiment are applicable to the network side device embodiment, and a same technical effect can be achieved.

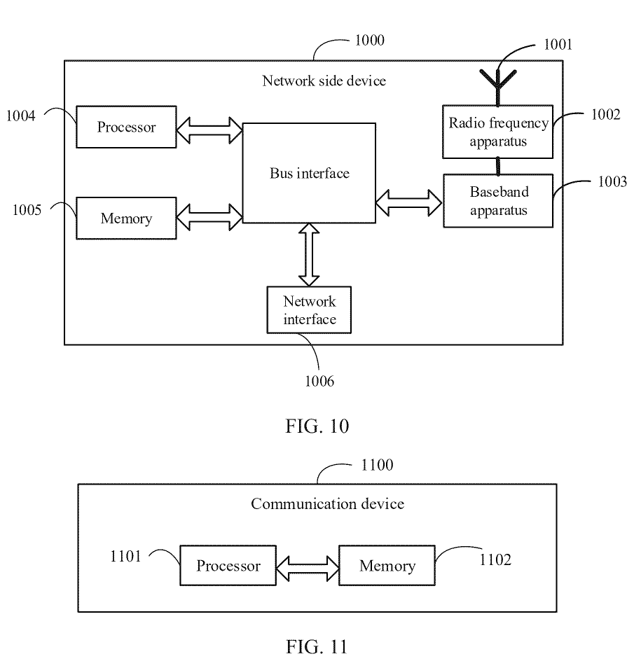

Specifically, an embodiment of this application further provides a network side device. As shown in FIG. 10, the network side device 1000 includes an antenna 1001, a radio frequency apparatus 1002, a baseband apparatus 1003, a processor 1004, and a memory 1005. The antenna 1001 is connected to the radio frequency apparatus 1002. In an uplink direction, the radio frequency apparatus 1002 receives information through the antenna 1001, and sends the received information to the baseband apparatus 1003 for processing. In a downlink direction, the baseband apparatus 1003 processes to-be-sent information, and sends the processed information to the radio frequency apparatus 1002. After processing the received information, the radio frequency apparatus 1002 sends the processed information through the antenna 1001.

A method performed by the network side device in the foregoing embodiment may be implemented in the baseband apparatus 1003. The baseband apparatus 1003 includes a baseband processor.

For example, the baseband apparatus 1003 may include at least one baseband board. A plurality of chips are disposed on the baseband board. As shown in FIG. 10, one of the chips is, for example, the baseband processor, and is connected to the memory 1005 through a bus interface, to invoke a program in the memory 1005 to perform an operation of a network side device shown in the foregoing method embodiment.

The network side device may further include a network interface 1006. For example, the interface is a common public radio interface (CPRI).

Specifically, the network side device 1000 in this embodiment of this application further includes instructions or a program stored in the memory 1005 and capable of running on the processor 1004. The processor 1004 invokes the instructions or the program in the memory 1005 to perform the method performed by the modules shown in FIG. 9, and a same technical effect is achieved. To avoid repetition, details are not described herein again.

An embodiment of this application further provides a readable storage medium. The readable storage medium stores a program or instructions. The processes in the foregoing information transmission method embodiment are implemented when the program or instructions are executed by a processor, and a same technical effect can be achieved. To avoid repetition, details are not described herein again.

The processor is a processor in the network side device in the foregoing embodiments. The readable storage medium may be non-volatile, or may be non-transitory. The readable storage medium may include a computer-readable storage medium, such as a computer read-only memory (ROM), a random access memory (RAM), a magnetic disk, or an optical disc.

Optionally, as shown in FIG. 11, an embodiment of this application further provides a communication device 1100, including a processor 1101 and a memory 1102. The memory 1102 stores a program or instructions capable of running on the processor 1101. For example, when the communication device 1100 is a terminal, the steps in the foregoing measurement switching method embodiment are implemented when the program or instructions are executed by the processor 1101, and a same technical effect can be achieved. When the communication device 1100 is a network side device, the steps in the foregoing information transmission method embodiment are implemented when the program or instructions are executed by the processor 1101, and a same technical effect can be achieved. To avoid repetition, details are not described herein again.

An embodiment of this application further provides a chip. The chip includes a processor and a communication interface. The communication interface is coupled to the processor. The processor is configured to run a program or instructions to implement the processes in the foregoing measurement switching method or information transmission method embodiment, and a same technical effect can be achieved. To avoid repetition, details are not described herein again.

It should be understood that the chip mentioned in this embodiment of this application may also be referred to as a system-level chip, a system chip, a chip system, a system on chip, or the like.

An embodiment of this application further provides a computer program/program product. The computer program/program product is stored in a storage medium. The computer program/program product is executed by at least one processor to implement the processes in the foregoing information transmission method embodiment, and a same technical effect can be achieved. To avoid repetition, details are not described herein again.

An embodiment of this application further provides a communication system, including a terminal and a network side device. The terminal may be configured to perform the steps of the foregoing measurement switching method, and the network side device may be configured to perform the steps of the foregoing information transmission method.

It should be noted that in this specification, the term “include”, “comprise”, or any of their variants is intended to cover a non-exclusive inclusion, so that a process, method, article, or apparatus that includes a list of elements not only includes those elements but also includes other elements that are not expressly listed, or further includes elements inherent to such a process, method, article, or apparatus. Without more constraints, an element preceded by “includes a . . . ” does not preclude the existence of additional identical elements in the process, method, article, or apparatus that includes the element. In addition, it should be noted that the scope of the method and apparatus in the implementations of this application is not limited to performing functions in a sequence shown or discussed, and may further include performing functions in a basically simultaneous manner or in a reverse sequence based on related functions. For example, the described method may be performed in an order different from the described order, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by a computer software product and a necessary general-purpose hardware platform, or certainly may be implemented by hardware. The computer software product is stored in a storage medium (such as a ROM, a RAM, a magnetic disk, or an optical disc) and includes several instructions for enabling a terminal or a network side device to perform the methods described in the embodiments of this application.

The foregoing describes the embodiments of this application with reference to the accompanying drawings. However, this application is not limited to the foregoing specific implementations. The foregoing specific implementations are merely illustrative rather than restrictive. Inspired by this application, a person of ordinary skill in the art may develop many forms of implementations without departing from principles of this application and the protection scope of the claims, and all such implementations fall within the protection scope of this application.

What is claimed is:

1. A measurement switching method, comprising:
obtaining, by a terminal, a first measurement result corresponding to a first measurement behavior; and
determining, by the terminal based on the first measurement result and a measurement switching threshold, whether to switch to a second measurement behavior, wherein the measurement switching threshold is related to at least one of: a type of a low power receiver of the terminal; or a signal type measured by a low power receiver.

2. The method according to claim 1, wherein the first measurement behavior or the second measurement behavior comprises at least one of the following:
using the low power receiver to perform measurement;
using the low power receiver to perform measurement and using a receiver of a main communication module to perform measurement of a first period; or
using a receiver of a main communication module to perform measurement of a second period, wherein
the second period is less than the first period.

3. The method according to claim 1, wherein the type of the low power receiver comprises at least one of the following:
having a capability of demodulating an on-off keying signal but not of detecting a modulation sequence of a modulated on signal;
having a capability of demodulating an on-off keying signal and detecting a modulation sequence of a modulated on signal;
having a capability of demodulating an on-off keying signal but not of detecting a complex signal sequence; or
having a capability of detecting a complex signal sequence.

4. The method according to claim 3, wherein the having a capability of detecting a complex signal sequence comprises having a capability of demodulating an on-off keying signal and detecting a complex signal sequence.

5. The method according to claim 1, further comprising:
obtaining, by the terminal, a measurement switching threshold corresponding to at least one type of low power receiver.

6. The method according to claim 5, wherein the obtaining, by the terminal, a measurement switching threshold corresponding to at least one type of low power receiver comprises at least one of the following:
receiving, by the terminal, a plurality of measurement switching thresholds sent by a network side device, wherein one measurement switching threshold corresponds to one type of low power receiver;
receiving, by the terminal, corresponding threshold configuration information based on the type of the low power receiver, wherein the threshold configuration information comprises the measurement switching threshold; or
receiving, by the terminal, a threshold offset value and a measurement switching threshold corresponding to a type of a first low power receiver that are sent by a network side device, and obtaining a measurement switching threshold corresponding to a type of a second low power receiver based on the threshold offset value and the measurement switching threshold corresponding to the type of the first low power receiver.

7. The method according to claim 1, further comprising:
obtaining, by the terminal, a measurement switching threshold corresponding to a combination of at least one type of low power receiver and a signal type measured by the terminal by using the low power receiver, wherein the signal type measured by the low power receiver comprises at least one of the following:
a synchronization signal block (SSB);
an on signal or an off signal of an on-off keying signal of a low power synchronization signal (LP-SS); or
a modulation sequence signal in an on-off keying signal of an LP-SS.

8. The method according to claim 7, wherein the obtaining a measurement switching threshold corresponding to a combination of at least one type of low power receiver and a signal type measured by the terminal by using the low power receiver comprises at least one of the following:
receiving, by the terminal, a plurality of measurement switching thresholds sent by a network side device, wherein one measurement switching threshold corresponds to one type of low power receiver and one signal type measured by the low power receiver of the terminal;
obtaining, by the terminal, corresponding threshold configuration information based on the type of the low power receiver and the signal type measured by the low power receiver, wherein the threshold configuration information comprises the measurement switching threshold; or
receiving, by the terminal, a threshold offset value and a measurement switching threshold corresponding to a type of a first low power receiver and a signal type measured by the first low power receiver that are sent by a network side device, and obtaining, based on the threshold offset value and the measurement switching threshold corresponding to the type of the first low power receiver and the signal type measured by the first low power receiver, a measurement switching threshold corresponding to a type of a second low power receiver and a signal type measured by the second low power receiver.

9. The method according to claim 8, wherein the obtaining corresponding threshold configuration information based on the type of the low power receiver and the signal type measured by the low power receiver comprises at least one of the following:
determining, if the signal type measured by the terminal is the SSB and the low power receiver of the terminal has a capability of detecting a modulation sequence of a modulated on signal or detecting a complex signal sequence, that the corresponding threshold is a threshold corresponding to the low power receiver;
determining, if the signal type measured by the terminal is the modulation sequence signal in the on-off keying signal of the LP-SS and the low power receiver of the terminal has a capability of detecting a modulation sequence of a modulated on signal or detecting a complex signal sequence, that the corresponding threshold is a threshold corresponding to a target low power receiver, wherein the target low power receiver does not have the capability of detecting a modulation sequence of a modulated on signal or does not have the capability of detecting a complex signal sequence; or
determining, if the signal type measured by the terminal is the on signal or the off signal of the on-off keying signal of the LP-SS and the low power receiver of the terminal does not have a capability of detecting a modulation sequence of a modulated on signal or detecting a complex signal sequence, that the corresponding threshold is a threshold corresponding to the low power receiver.

10. The method according to claim 1, further comprising:
obtaining, by the terminal, a measurement switching threshold corresponding to at least one signal type measured by the low power receiver, wherein the signal type measured by the low power receiver comprises at least one of the following:
an SSB; or
an LP-SS.

11. The method according to claim 10, wherein the obtaining, by the terminal, a measurement switching threshold corresponding to at least one signal type measured by the low power receiver comprises at least one of the following:
receiving, by the terminal, a plurality of measurement switching thresholds sent by a network side device, wherein one measurement switching threshold corresponds to one signal type measured by the low power receiver;
receiving, by the terminal, corresponding threshold configuration information based on the signal type measured by the low power receiver, wherein the threshold configuration information comprises the measurement switching threshold; or
receiving, by the terminal, a threshold offset value and a measurement switching threshold corresponding to a first signal type measured by the low power receiver that are sent by a network side device, and obtaining, based on the threshold offset value and the measurement switching threshold corresponding to the first signal type measured by the low power receiver, a measurement switching threshold corresponding to a second signal type measured by the low power receiver.

12. The method according to claim 10, wherein in a case that the signal type measured by the low power receiver is the LP-SS, the LP-SS comprises at least one of the following: an on signal or an off signal of an on-off keying signal of the LP-SS or a modulation sequence signal in an on-off keying signal of the LP-SS.

13. A non-transitory readable storage medium, wherein the readable storage medium stores a program or instructions, and the steps of the measurement switching method according to claim 1 are implemented when the program or instructions are executed by a processor.

14. An information transmission method, comprising:
notifying, by a network side device, a terminal of a measurement switching threshold corresponding to at least one type of low power receiver;
notifying, by a network side device, a terminal of a measurement switching threshold corresponding to a combination of at least one type of low power receiver and a signal type measured by the terminal by using the low power receiver, wherein the signal type measured by the low power receiver comprises at least one of the following: a synchronization signal block (SSB), an on signal or an off signal of an on-off keying signal of a low power synchronization signal (LP-SS), or a modulation sequence signal in an on-off keying signal of an LP-SS; or
notifying, by a network side device, a terminal of a measurement switching threshold corresponding to at least one signal type measured by a low power receiver, wherein the signal type measured by the low power receiver comprises at least one of the following: an SSB or an LP-SS.

15. The method according to claim 14, wherein the notifying, by a network side device, a terminal of a measurement switching threshold corresponding to at least one type of low power receiver comprises at least one of the following:
sending, by the network side device, a plurality of measurement switching thresholds to the terminal, wherein one measurement switching threshold corresponds to one type of low power receiver;
sending, by the network side device, threshold configuration information corresponding to the type of the low power receiver to the terminal, wherein the threshold configuration information comprises the measurement switching threshold; or
sending, by the network side device, a threshold offset value and a measurement switching threshold corresponding to a type of a first low power receiver to the terminal, wherein the threshold offset value is used to indicate an offset between a measurement switching threshold of a type of a second low power receiver and the measurement switching threshold corresponding to the type of the first low power receiver.

16. The method according to claim 14, wherein the notifying, by a network side device, a terminal of a measurement switching threshold corresponding to a combination of at least one type of low power receiver and a signal type measured by the terminal by using the low power receiver comprises at least one of the following:
sending, by the network side device, a plurality of measurement switching thresholds to the terminal, wherein one measurement switching threshold corresponds to one type of low power receiver and one signal type measured by the low power receiver of the terminal;
sending, by the network side device, threshold configuration information corresponding to the type of the low power receiver and the signal type measured by the low power receiver to the terminal, wherein the threshold configuration information comprises the measurement switching threshold; or
sending, by the network side device, a threshold offset value and a measurement switching threshold corresponding to a type of a first low power receiver and a signal type measured by the first low power receiver to the terminal, wherein the threshold offset value is used to indicate an offset between a measurement switching threshold corresponding to a type of a second low power receiver and a signal type measured by the second low power receiver and the measurement switching threshold corresponding to the type of the first low power receiver and the signal type measured by the first low power receiver.

17. The method according to claim 14, wherein the notifying, by a network side device, a terminal of a measurement switching threshold corresponding to at least one signal type measured by a low power receiver comprises at least one of the following:
sending, by the network side device, a plurality of measurement switching thresholds to the terminal, wherein one measurement switching threshold corresponds to one signal type measured by the low power receiver;
sending, by the network side device, threshold configuration information corresponding to the signal type measured by the low power receiver to the terminal, wherein the threshold configuration information comprises the measurement switching threshold; or
sending, by the network side device, a threshold offset value and a measurement switching threshold corresponding to a first signal type measured by the low power receiver to the terminal, wherein the threshold offset value is used to indicate an offset between a measurement switching threshold corresponding to a second signal type measured by the low power receiver and the measurement switching threshold corresponding to the first signal type measured by the low power receiver.

18. The method according to claim 14, further comprising:
generating, by the network side device, a measurement signal in a first manner; and
sending, by the network side device, the measurement signal, wherein the first manner comprises at least one of the following:
determining an on-off keying signal as the measurement signal;
modulating an on-off keying signal based on whether to send an orthogonal frequency division multiplexing (OFDM) signal sequence;
generating an on-off keying signal by generating a plurality of on or off states within duration of one OFDM symbol;
carrying a modulated on-off keying signal by using different OFDM signal sequences;
generating an on-off keying signal in one OFDM symbol by using different OFDM signal sequences; or
determining a synchronization signal block or a target reference signal in a synchronization signal block as the measurement signal, wherein the target reference signal comprises a primary synchronization signal (PSS) or a secondary synchronization signal (SSS).

19. A network side device, comprising a processor and a memory, wherein the memory stores a program or instructions capable of running on the processor, and the steps of the information transmission method according to claim 14 are implemented when the program or instructions are executed by the processor.

20. A terminal, comprising a processor and a memory, wherein the memory stores a program or instructions capable of running on the processor, and the processor, through executing the program or instructions, is configured to:
obtain a first measurement result corresponding to a first measurement behavior; and
determine, based on the first measurement result and a measurement switching threshold, whether to switch to a second measurement behavior, wherein the measurement switching threshold is related to at least one of: a type of a low power receiver of the terminal; or a signal type measured by a low power receiver.
